(19) United States
(12) Patent Application Publication
(10) Pub. No.: US 2025/0296283 A1
(43) Pub. Date: Sep. 25, 2025

(54) HOPPING LIGHT ADDITIVE MANUFACTURING

(71) Applicant: University of Southern California, Los Angeles, CA (US)

(72) Inventors: Yong Chen, Los Angeles, CA (US); Huachao Mao, Los Angeles, CA (US)

(73) Assignee: University of Southern California, Los Angeles, CA (US)

(21) Appl. No.: 18/863,456

(22) PCT Filed: Mar. 31, 2023
(86) PCT No.: PCT/US2023/017083

§ 371 Date: Nov. 6, 2024

Related U.S. Application Data
(60) Provisional application No. 63/341,822, filed on May 13, 2022.

(51) Int. Cl. B29C 64/268; B29C 64/129; B29C 64/153; B29C 64/393; B33Y 10/00; B33Y 30/00; B33Y 50/02; G02B 26/08

(52) U.S. Cl. CPC B29C 64/268; B29C 64/129; B29C 64/153; B29C 64/393; B33Y 10/00; B33Y 30/00; B33Y 50/02; G02B 26/0833

(57) ABSTRACT

The stereolithography system includes a light source configured to project an image or a light onto a substrate, a rotating mirror configured to reflect the image or the light at the substrate, an actuator coupled to a linear stage and configured to move or position the linear stage, and a controller coupled to the light source, the rotating mirror and the actuator. The controller is configured to determine a rotation speed of the rotating mirror to transition speed of the linear stage ratio that keeps the image at a fixed position, project the image or the light onto the substrate at the fixed position, and operate the actuator and the rotating mirror based on the rotation speed to transition speed ratio.

### CROSS-REFERENCE TO RELATED APPLICATIONS

This application claims priority to U.S. Provisional Patent Application No. 63/341,822, entitled “Hopping Light Additive Manufacturing”, filed May 13, 2022 which is hereby incorporated by reference in its entirety.

### STATEMENT AS TO FEDERALLY SPONSORED RESEARCH

This invention was made with government support under contract number CMMI 1151191 awarded by the National Science Foundation (NSF). The government has certain rights in this invention.

### FIELD

The present disclosure generally relates to additive manufacturing, and more particularly, to high resolution stereolithography and selective laser sintering/melting used in additive manufacturing.

### BACKGROUND

Stereolithography (SL) is used as an additive manufacturing process. Typically, there are two types of SL processes according to the light source that the process uses. First, using the laser-based small spots and second, the projection-based mask images. The laser-based SL process has been in use for years and various efforts have been done to improve both the laser-based and projection-based SL processes including fabrication speed, part size, geometry resolution, and scalability. However, there are considerations to be made when choosing among the fabrication performances in the SL process. Various aspects of the SL process may limit broader applications, including fabrication resolution versus speed, fabrication resolution versus part size, and part size versus fabrication speed. These tradeoffs emerge from the principle of SL.

### SUMMARY

Disclosed herein is stereolithography system. The stereolithography system includes a light source configured to project an image or a light onto a substrate, a rotating mirror configured to reflect the image or the light at the substrate, an actuator coupled to a linear stage and configured to move or position the linear stage, and a controller coupled to the light source, the rotating mirror and the actuator. The controller is to determine a rotation speed of the rotating mirror to transition speed of the linear stage ratio that keeps the image at a fixed position, project the image or the light onto the substrate at the fixed position, and operate the actuator and the rotating mirror based on the rotation speed to transition speed ratio.

In various embodiments, the light source is a digital micromirror device (DMD) that is configured to project the image onto the substrate, wherein the rotating mirror is a galvo mirror that is driven by a motor. In various embodiments, to operate the actuator and the rotating mirror based on the rotation speed to transition speed ratio the controller is configured to simultaneously rotate or angle the rotating mirror from a first angle to a second angle while moving the linear stage from a first position to a second position using the actuator so that the image or the light remains at the fixed position.

In various embodiments, to operate the actuator and the rotating mirror based on the rotation speed to transition speed ratio the controller is further configured to deactivate the light source or load a black image into the light source when the linear stage reaches the second position, rotate or angle the rotating mirror from the second angle to the first angle when the linear stage reaches the second position, activate the light source, load a new image related to the second fixed position into the light source, project the image or the light onto the substrate at a second fixed position, and rotate or angle the rotating mirror from the first angle to the second angle while moving the linear stage from the second position to a third position so that the image or the light remains at the second fixed position.

In various embodiments, at least one of a timer or the controller is configured to control an exposure time of the projected image or light onto the substrate. In various embodiments, to operate the actuator and the rotating mirror based on the rotation speed to transition speed ratio the controller is configured to synchronize the projection of the image or the light, the rotation of the rotating mirror and the movement of the linear stage by the actuator to maintain the projected image or light at the fixed position while the linear stage is moving until the projected image or light jumps or hops to a second fixed position.

In various embodiments, the stereolithography system further includes a resin tank configured to store or hold the substrate, wherein the substrate is resin, and a microscope that is configured to capture the projected image on light on a plane of the resin. In various embodiments, the controller is configured to individually calibrate the rotating mirror, the actuator and the light source, estimate a transition speed of the linear stage based on a motion of the actuator, estimate a rotation speed of the rotating mirror, determine the rotation speed of the rotating mirror to transition speed of the linear stage ration based on the transition speed and the rotation speed to correct motion blur, and tune an image pattern of the projected image to ensure a seamless stitch and reduce or eliminate motion blur during continuous movement of the linear stage.

Also disclosed herein is a computer-implemented method including determining, by a processor, a ratio of a rotation speed of a rotating mirror to a movement speed of a linear stage ratio to maintain an image at a fixed position to prevent or correct motion blur, projecting, using the processor and by a digital micromirror device (DMD), an image onto resin at a fixed position to cure the resin, and operating, by the processor, one or more actuators or motors to move the linear stage and rotate the rotating mirror based on the rotation speed to movement speed ratio.

In various embodiments, the computer-implemented method further includes estimating the movement speed of the linear stage based on a motion of the actuator, estimating the rotation speed of the rotating mirror, and determining the rotation speed of the rotating mirror to movement speed of the linear stage ratio based on the estimated movement speed and the estimated rotation speed to correct motion blur. In various embodiments, the computer-implemented method further includes calibrating the rotating mirror, the actuator and the DMD, and tuning an image pattern of the projected image to ensure a seamless stitch and reduce or eliminate motion blur during continuous movement of the linear stage.

In various embodiments, operating the one or more actuators or motors to move the linear stage and rotate the rotating mirror based on the rotation speed to movement speed ratio includes synchronizing the projection of the image, the rotation of the rotating mirror and the movement of the linear stage to maintain the projected image or light at the fixed position while the linear stage is moving until the projected image jumps or hops to a second fixed position. In various embodiments, operating the one or more actuators or motors to move the linear stage and rotate the rotating mirror based on the rotation speed to movement speed ratio includes simultaneously rotating or angling the rotating mirror from a first angle to a second angle while moving the linear stage from a first position to a second position so that the image remains at the fixed position.

In various embodiments, operating the one or more actuators or motors to move the linear stage and rotate the rotating mirror based on the rotation speed to movement speed ratio includes deactivating the DMD when the linear stage reaches the second position, rotating the rotating mirror from the second angle to the first angle when the linear stage reaches the second position, activating the DMD, projecting the image onto the resin at a second fixed position, and rotating the rotating mirror from the first angle to the second angle while moving the linear stage from the second position to a third position so that the image remains at the second fixed position.

Also disclosed herein is a non-transitory computer-readable medium comprising computer readable instructions, which when executed by a processor, cause the processor to perform operations including determining a ratio of a rotation speed of a rotating mirror to a movement speed of a linear stage ratio to maintain an image at a fixed position to prevent or correct motion blur, projecting, using a digital micromirror device (DMD), an image onto resin at a fixed position to cure the resin, and operating one or more actuators or motors to move the linear stage and rotate the rotating mirror based on the rotation speed to movement speed ratio.

In various embodiments, the operations further include estimating the movement speed of the linear stage based on a motion of the actuator, estimating the rotation speed of the rotating mirror, and determining the rotation speed of the rotating mirror to movement speed of the linear stage ratio based on the estimated movement speed and the estimated rotation speed to correct motion blur. In various embodiments, the operations further include calibrating the rotating mirror, the actuator and the DMD, and tuning an image pattern of the projected image to ensure a seamless stitch and reduce or eliminate motion blur during continuous movement of the linear stage.

In various embodiments, operating the one or more actuators or motors to move the linear stage and rotate the rotating mirror based on the rotation speed to movement speed ratio includes synchronizing the projection of the image, the rotation of the rotating mirror and the movement of the linear stage to maintain the projected image or light at the fixed position while the linear stage is moving until the projected image jumps or hops to a second fixed position.

Also disclosed herein is a selective laser sintering/melting system, including a light source configured to project an image or a light onto a powder, a rotating mirror configured to reflect the image or the light at the powder an actuator coupled to a linear stage and configured to move or position the linear stage, and a controller coupled to the light source, the rotating mirror and the actuator and configured to determine a rotation speed of the rotating mirror to transition speed of the linear stage ratio that keeps the image at a fixed position, project the image or the light onto the powder at the fixed position, and operate the actuator and the rotating mirror based on the rotation speed to transition speed ratio.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

FIG. 1 shows an example block schematic diagram of a processing system employed to provide processing to implement the hopping light process, in accordance with various embodiments.

FIGS. 2A, 2B, and 2C show an example diagram of the stereolithography system that implements the hopping light process, in accordance with various embodiments.

FIG. 3 shows an example diagram of the selective laser sintering/melting system that implements the hopping light process, in accordance with various embodiments.

FIG. 4 shows an example hopping light process system framework, in accordance with various embodiments.

FIG. 5 shows a fabrication process using the hopping light process, in accordance with various embodiments.

FIGS. 6A and 6B show a framework from motion synchronization of a hopping light system, in accordance with various embodiments.

FIG. 7 shows a calibration framework for a hopping light system, in accordance with various embodiments.

FIG. 8 shows a method of performing a calibration process of a hopping light system, in accordance with various embodiments.

FIGS. 9A, 9B, 9C, 9D, 9E, and 9F show projection pixel sizes of a hopping light process in a microscope image space, in accordance with various embodiments.

FIG. 10 shows a calibration of the X stage motion of a hopping light process in the microscope image space, in accordance with various embodiments.

FIG. 11 shows a calibration of the rotation angle of a mirror in a hopping light system in the microscope image space, in accordance with various embodiments.

FIG. 12 shows a composite motion angle for calibration of a rotating mirror, in accordance with various embodiments.

FIG. 13 shows capture of two images using a hopping light process, in accordance with various embodiments.

FIGS. 14A, 14B, and 14C show an image stitching process of a hopping light process, in accordance with various embodiments.

FIGS. 15A and 15B show images before and after an image stitching process, in accordance with various embodiments.

FIG. 16 shows a system of analyzing focusing error of a hopping light process, in accordance with various embodiments.

FIG. 17 shows a focusing error distribution, in accordance with various embodiments.

FIG. 18 shows a system of projector motion of a hopping light process, in accordance with various embodiments.

FIG. 19 shows a graph of a max focus error of a hopping light process, in accordance with various embodiments.

FIGS. 20A and 20B show a system of combing image position of a hopping light process, in accordance with various embodiments.

FIG. 21 shows a graph that compares the effect of continuous moving light and discrete moving light, in accordance with various embodiments.

FIG. 22 shows a graph of curing time as a function of start and stop speeds, in accordance with various embodiments.

FIG. 23 shows a table of small feature test print images from a hopping light process, in accordance with various embodiments.

FIGS. 24A, 24B, 24C, 24D, 24E, and 24F show an image of a human lung slide and fabricated results using a hopping light process, in accordance with various embodiments.

FIGS. 25A, 25B, 25C, 25D, and 25E show a comparison of a CAD image and a final printed part using the hopping light process, in accordance with various embodiments.

FIGS. 26A, 26B, 26C, 26D, 26E, and 26F show a comparison of a triangle test pattern and a printed part using the hopping light process, in accordance with various embodiments.

FIGS. 27A, 27B, 27C, and 27D show an image pattern and a printed result using the hopping light process, in accordance with various embodiments.

FIGS. 28A, 28B, 28C, and 28D show an image pattern and a printed result using the hopping light process, in accordance with various embodiments.

FIGS. 29A, 29B, 29C, 29D, 29E, 29F, 29G, 29H, 29I, 29J, and 29K show an image pattern and a printed result using the hopping light process, in accordance with various embodiments.

FIGS. 30A, 30B, 30C, 30D, and 30E show an image pattern and a printed result using the hopping light process, in accordance with various embodiments.

### DETAILED DESCRIPTION

A system, apparatus and/or method for an additive manufacturing process that provides high fidelity and vast material functionality. The stereolithography (SL) process utilizes light energy (scanning laser spot or projected image) to trigger the photo-polymerization and solidify a whole layer of liquid photo-curable resin. Repeating this photo-polymerization layer by layer produces a three-dimensional object. The hopping light stereolithography (SL) system (hereinafter, referred to as “hopping SL system” or simply as a “stereolithography system”) provides large area high-resolution three-dimensional (3D) printing using a large area and high resolution SL process named hopping light stereolithography.

The hopping light SL process uses a motion blur correction method to achieve continuously moving projection light over a large building area. The hopping light SL system combines a XY linear stage and a rotating mirror so that the projection system can be moved continuously without stop-and-go, while the projection image can stay at a fixed position for a certain time for photocuring and hop to the next position when needed. By using such a continuously moving light method, the hopping light SL process can eliminate the extra time for translating the projection system using the stop-and-go method while keeping a relatively low image refreshing rate (less than 120 Hz). Compared with existing large area SL processes such as discrete scanning projection and continuous projection with a very high refresh rate, the developed hopping light process can quickly fabricate a large-size object with high resolution using a low-cost projection system. The hopping SL system synchronizes the motion of the various components to correct motion blur.

The hopping SL system is disclosed herein including a method of synchronized motion with motion blur corrected, calibration of the hopping SL system, and exemplary embodiments the hopping SL system. The hopping SL system is further described as set forth in Appendix A attached herein. In various embodiments, the hopping SL system improves the speed, resolution, and/or cost of critical fabrication properties. Other advantages the hopping SL system described herein will become apparent.

Stereolithography (SL) has become an important additive manufacturing process. Currently, there are two main types of SL processes according to the light source that the process uses, i.e., using the laser-based small spots and the projection-based mask images. The laser-based SL process was developed in the 1980s by Chuck Hull and commercialized by 3D Systems. Since then, various efforts have been done to improve both the laser-based and projection-based SL processes including fabrication speed, part size, geometry resolution, and scalability. However, three main considerations among the fabrication performances are to be made in the SL process that limits its broader applications, including (1) fabrication resolution versus speed, (2) fabrication resolution versus part size, and (3) part size versus fabrication speed. These tradeoffs emerge from the principle of SL.

For the laser-based SL, the principle is to solidify each layer by scanning a small laser spot to fill the whole area. Due to the time-consuming scanning, the laser-based SL has unsatisfactory fabrication speed especially for large parts with complex small features, while the resolution could be high if the laser spot is focused to be small (e.g., 10 μm). On the contrary, the projection-based SL process utilizes a mask image to solidify a large area simultaneously. The mask image can be tuned by a digital mirror device, e.g., a digital micromirror device (DMD) or a Liquid Crystal Device (LCD), which controls the energy level of each pixel in order to generate an arbitrary image. Compared with laser-based SL processes, the projection-based SL processes can achieve a faster speed regardless of the input geometric shapes [4] [5].

However, the limited number of the total pixels in a mask image sets a bottleneck for the projection-based SL process to fabricate a part with a large size that requires a high resolution at the same time. That is, since the total pixels of a mask image is fixed (e.g., a typical DMD can only have a maximum of 1920×1080 pixels), the part-size-to-feature-size ratio in the projection-based SL process (e.g., PμSL [10] [13] and CLIP [6]) is limited, which leads to the difficulty in fabricating a large-size part with highly detailed geometric features.

In various embodiments, a method to enlarge the total number of pixels of each layer is to project multiple images for one layer, and thus the total number of pixels could be largely increased by the number of images in one layer. For example, [1] and [14] segment one layer into many sections, and project an image to the first section; then move the projector to the adjacent section, stop the movement and begin to project a corresponding image for this section; afterwards, the procedure is repeated to fill all the sections. Although such a stop-and-project method can achieve large area fabrication with a high resolution, the fabrication speed is slow due to the extra stop-and-go required in the projection image transition time.

In various embodiments, an improvement to fabrication speed, Suman Das [2] may include a continuous moving light method called Large Area Maskless Photopolymerization (LAMP) to eliminate this stop-and-go transition time. In LAMP, the projector is continuously moved, and the projection images are continuously refreshed according to the projector's current position. This continuously moving light method is advantageous on its fabrication speed; however, two fundamental issues arise. First, because of the continuous motion, the projector needs to refresh the image at each pixel's distance (e.g., 5 μm). It requires a high-speed refresh rate in order to achieve a fast moving speed. Further, if the exposure time for each pixel is reduced, for example, in the situation of a high Z-axis resolution (i.e., with a small layer thickness), the required refresh rate becomes incredibly high, e.g., 10,000 Hz, which is very hard for current DMD chips. The related projection image controller is expensive and the task of planning millions of images to fabricate a layer is challenging. Accordingly, without such super high refreshing rate, the projection images are blurred due to the moving pixels.

To avoid the refresh rate issue, an exemplary process called LAPuPL [16] developed by Moran, which used two scanning mirrors to change the position of each image rapidly. Zheng [10] used this process to fabricate multiscale objects with high lateral resolution. However, a customized f-theta lens is used to solve the de-focus issue of a tilted image. Even with a customized focusing f-theta lens, the building area of LAPuPL is limited to a relatively small area compared with LAMP due to the limited field of view.

This disclosure presents a novel SL method to simultaneously achieve large fabrication area, high feature resolution, and fast fabrication speed. The hopping light method can continuously move the projection image and, at the same time, without the use of super high refresh rate. In various embodiments, the method combines a XY linear stage and a rotating mirror that can provide a complementary motion of the image, so that the projection image can be fixed at a position for a certain time while the projection system is continuously moving. Therefore, the motion blur associated with the projection system's linear movement can be corrected with the synchronized motions between the moving stage and the rotation mirror.

Disclosed herein are a method of the motion blur correction, a method of calibrating the hopping LS system, a method of controlling defocus of a slightly tilted image, and a comparison of the proposed method with other commonly used SLA processes. A variety of experiments have been performed and results are presented herein to demonstrate the effectiveness of the developed hopping SL system.

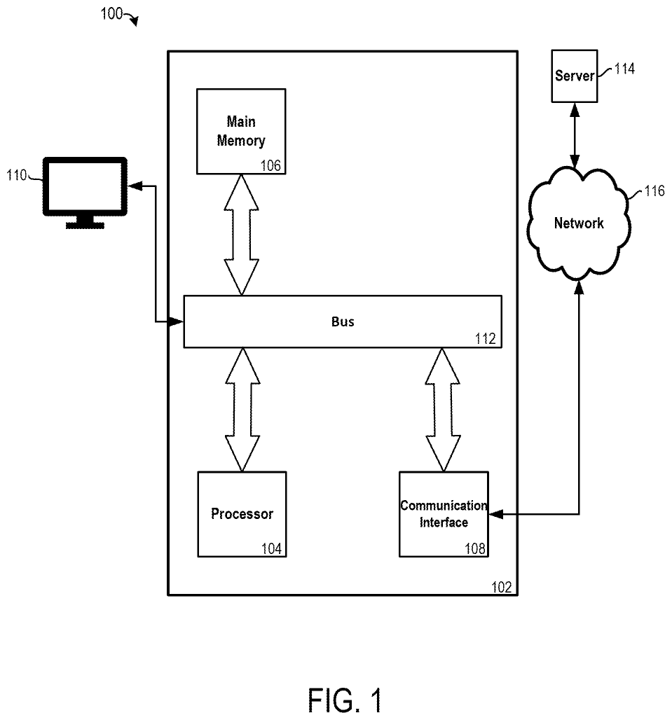

Referring now to FIG. 1, a computing system 100 that may be included and/or work in conjunction with the stereolithography system or other additive manufacturing system, such as a selective laser sintering/melting system is illustrated, in accordance with various embodiments. The computing system 100 may include a computing device 102 that has one or more processors 104, a memory 106 and/or a bus 112 and/or other mechanisms for communicating between the one or more processors 104. The one or more processors 104 may be implemented as a single processor or as multiple processors. The one or more processors 104 may execute instructions stored in the memory 106 to implement the applications and/or detection of the computing system 100.

The one or more processors 104 may be coupled to the memory 106. The memory 106 may include one or more of a Random Access Memory (RAM) or other volatile or non-volatile memory. The memory 106 may be a non-transitory memory or a data storage device, such as a hard disk drive, a solid-state disk drive, a hybrid disk drive, or other appropriate data storage, and may further store machine-readable instructions, which may be loaded and executed by the one or more processors 104.

The memory 106 may include one or more of random access memory (“RAM”), static memory, cache, flash memory and any other suitable type of storage device or computer readable storage medium, which is used for storing instructions to be executed by the one or more processors 104. The storage device or the computer readable storage medium may be a read only memory (“ROM”), flash memory, and/or memory card, that may be coupled to a bus 112 or other communication mechanism. The storage device may be a mass storage device, such as a magnetic disk, optical disk, and/or flash disk that may be directly or indirectly, temporarily or semi-permanently coupled to the bus 112 or other communication mechanism and used be electrically coupled to some or all of the other components within the computing system 100 including the memory 106, the user interface 110 and/or the communication interface 108 via the bus 112.

The term “computer-readable medium” is used to define any medium that can store and provide instructions and other data to a processor, particularly where the instructions are to be executed by a processor and/or other peripheral of the processing system. Such medium can include non-volatile storage, volatile storage and transmission media. Non-volatile storage may be embodied on media such as optical or magnetic disks. Storage may be provided locally and in physical proximity to a processor or remotely, typically by use of network connection. Non-volatile storage may be removable from computing system, as in storage or memory cards or sticks that can be easily connected or disconnected from a computer using a standard interface.

The computing system 100 may include a user interface 110. The user interface 110 may include an input/output device. The input/output device may receive user input, such as a user interface element, hand-held controller that provides tactile/proprioceptive feedback, a button, a dial, a microphone, a keyboard, or a touch screen, and/or provides output, such as a display, a speaker, an audio and/or visual indicator, or a refreshable braille display. The display may be a computer display, a tablet display, a mobile phone display, an augmented reality display or a virtual reality headset. The display may output or provide a virtual environment that mimics actions of the patient and/or provide information regarding the neural activity of the patient or other information.

The user interface 110 may include an input/output device that receives user input, such as a user interface element, a button, a dial, a microphone, a keyboard, or a touch screen, and/or provides output, such as a display, a speaker, headphones, an audio and/or visual indicator, a device that provides tactile/proprioceptive feedback or a refreshable braille display. The speaker may be used to output audio associated with the audio conference and/or the video conference. The user interface 110 may receive user input that may include configuration settings for one or more user preferences, such as a selection of joining an audio conference or a video conference when both options are available, for example.

The computing system 100 may have a network 116 that couples a server 114 with the computing device 102. The network 116 may be a local area network (LAN), a wide area network (WAN), a cellular network, the Internet, or combination thereof, that connects, couples and/or otherwise communicates between the various components of the system 100 with the server 114. The server 114 may be a remote computing device or system that includes a memory, a processor and/or a network access device coupled together via a bus. The server 114 may be a computer in a network that is used to provide services, such as accessing files or sharing peripherals, to other computers in the network.

The computing system 100 may include a communication interface 108, such as a network access device. The communication interface 108 may include a communication port or channel, such as one or more of a Dedicated Short-Range Communication (DSRC) unit, a Wi-Fi unit, a Bluetooth® unit, a radio frequency identification (RFID) tag or reader, or a cellular network unit for accessing a cellular network (such as 3G, 4G or 5G). The communication interface may transmit data to and receive data among the different components.

The server 114 may include a database. A database is any collection of pieces of information that is organized for search and retrieval, such as by a computer, and the database may be organized in tables, schemas, queries, reports, or any other data structures. A database may use any number of database management systems. The information may include real-time information, periodically updated information, or user-inputted information.

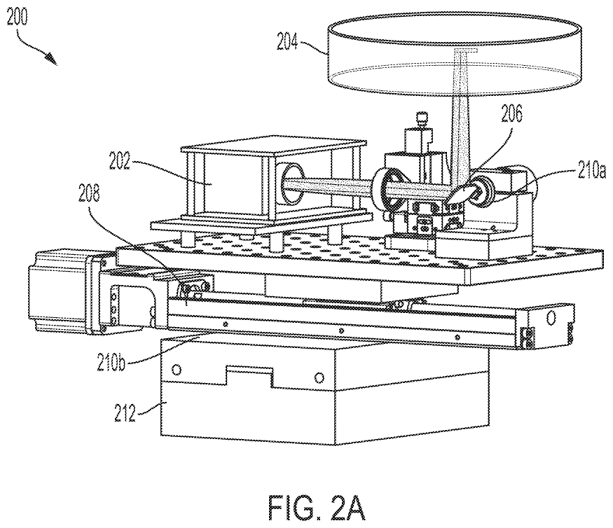

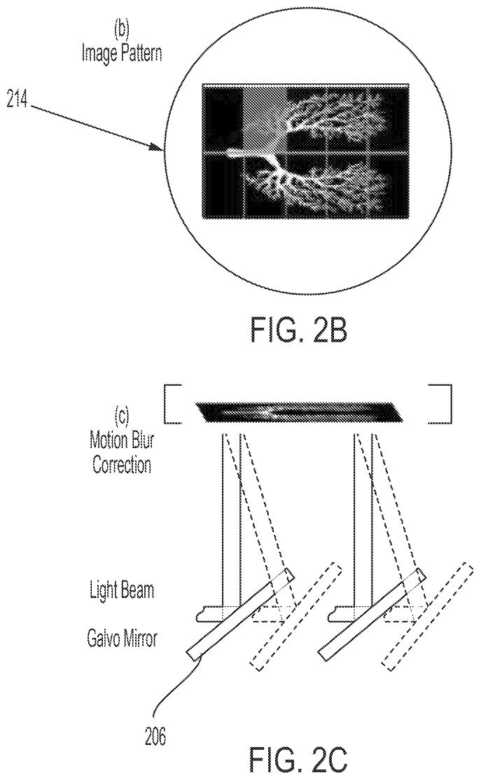

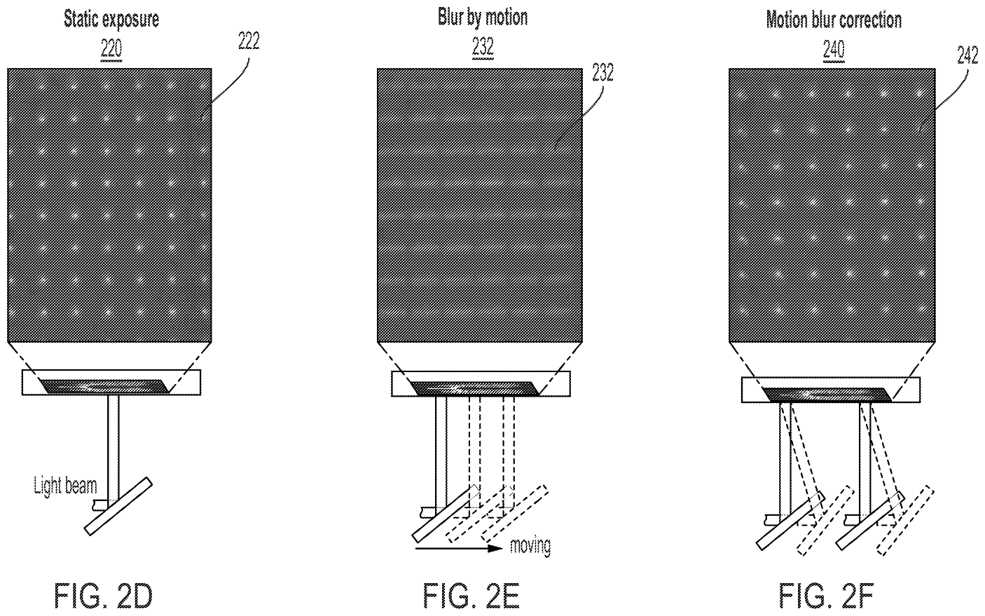

Referring now to FIGS. 2A-2F, an example stereolithography system 200 is illustrated, in accordance with various embodiment. In various embodiments, stereolithography system 200 may be used to correct motion blur. Stereolithography system 200 includes a digital micromirror device (DMD) 202, a resin tank 204, a rotating mirror 206, one or more actuators and/or motors 210a-b, and a linear stage 208. In various embodiments, rotating mirror 206 may be a galvo mirror. In various embodiments, the one or more actuators and/or motors 210a-b may move, adjust, rotate or otherwise position the linear stage 208 or the rotating mirror 206. The computing system 100 may couple to or be included in the stereolithography system 200 and/or may include or be coupled to a controller 212 that is part of the stereolithography system 200 to control the one or more actuators and/or motors 210a-b. Stereolithography system 200, and more specifically, DMD 202, may project an image pattern 214 onto resin tank 204, illustrated in FIG. 2B. DMD 202 may be configured to project image pattern 214 with a continuous movement. Incorporating rotating mirror 206 in stereolithography system 200 may cancel out the image motion that is introduced by the continuous movement of DMD 202, as illustrated in FIG. 2C. In various embodiments, rotating mirror 206 may tilt the light beam so that image pattern 214 stays at a fixed position.

Due to the motion of DMD 202, image pattern 214 will be blurred if image pattern 214 is not quickly refreshed after moving each pixel's distance. FIG. 2D illustrates a static exposure 220 of an image pattern (e.g., image pattern 214) that does not induce motion blur. FIG. 2E illustrates a motion blur exposure 230 caused by DMD 202 is continuously moving during the light exposure. FIG. 2E shows the blurred image captured at the focal plane by a microscope. In FIG. 2E, bright dots 222 are moved so that they form darker lines 232, similar to motion blur in photography. Such a blurred image leads to blurred printed features and even under-cured features. FIG. 2F illustrates a motion blur exposure 240 using rotating mirror 206 (e.g., a galvo mirror) to compensate the X stage linear motion and to guarantee the projected image (e.g., image pattern 214) has no motion blur (e.g., dots 242) while the X stage of the hopping SL system is continuously moving.

In various embodiments, this process divides one layer of a large area into a set of small sections, which will be cured one by one, as illustrated in FIGS. 2B and 2C. The transition between the sections may be realized by moving the stereolithography system 200 using the XY linear stage. However, unlike typical discrete movement of a projector system, DMD 202 in stereolithography system 200 moves continuously, while the image (e.g., image pattern 214) for a particular section will be fixed at that area by using rotating mirror 206 (e.g., a galvo-mirror) to create a complementary reverse motion to cancel out the linear movement of DMD 202. Hence, by incorporating both XY linear stage and rotating mirror 206, the mask video projection process can generate mask images (e.g., image pattern 214) at a set of fixed positions to solidify a 3D object while maintaining a fast moving speed to quickly cover a large building area.

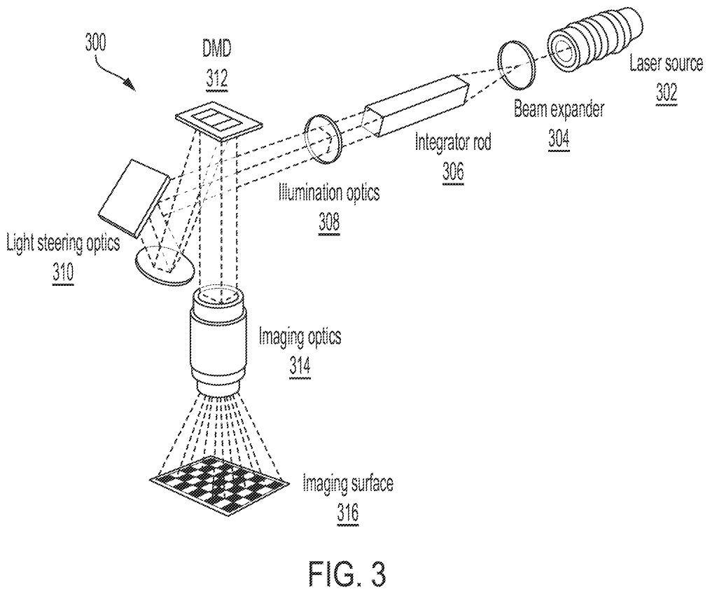

Referring now to FIG. 3, an exemplary selective laser sintering/melting system 300 (or “SLS/SLM system”) is illustrated, in accordance with various embodiments. SLS/SLM system 300 may similarly employ a hopping light process or method. The hopping light processor or method may also be applied to other additive manufacturing processes that use light projection. SLS/SLM system 300 includes a laser source 302, a beam expander 304, an integrator rod 306, illumination optics 308, one or more light steering optics 310, a digital micromirror device (DMD) 312, imaging optics 314, and an imaging surface 316. In various embodiments, DMD 312, the one or more light steering optics 310, and imaging surface 316 may be examples of DMD 202, rotating mirror 206, and resin tank 204, respectively, described above in FIG. 2.

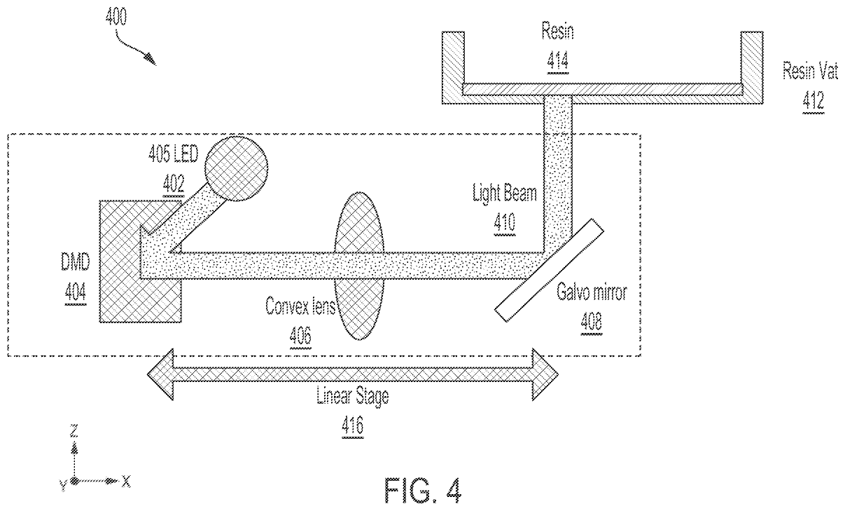

Referring now to FIG. 4, a hopping SL system framework 400 is illustrated, in accordance with various embodiments. In various embodiments, framework 400 may be an example of stereolithography system 200 described above in FIG. 2. Framework 400 includes an optical module 401 that includes a light source 402, a digital micromirror device (DMD) 404, an optic lens 406, a rotating mirror 408. Optical module 401 directs a light beam 410 onto a resin vat 412 filled with resin 414. In various embodiments, optic lens 406 may be a convex lens, similar to a conventional projection-based SL process. Optic lens 406 images a pattern from DMD 404 onto a focal plane of optic lens 406 with a certain magnification. In various embodiments, optical module 401 is mounted on an XY linear stage 416. That is, XY linear stage 416 is able to move in the x-direction and the y-direction. As illustrated in FIG. 4, the projected image's motion is a combination of XY linear stage 416 and rotation of rotating mirror 408 (e.g., a galvo-mirror). After passing rotating mirror 408, light beam 410 projects up (e.g., in the positive z-direction) to resin tank 412 containing liquid resin 414. The Z-axis lifts the platform, which carries the 3D printed objects. In various embodiments, this process may be used in both the bottom-up projection and the top-down projection systems.

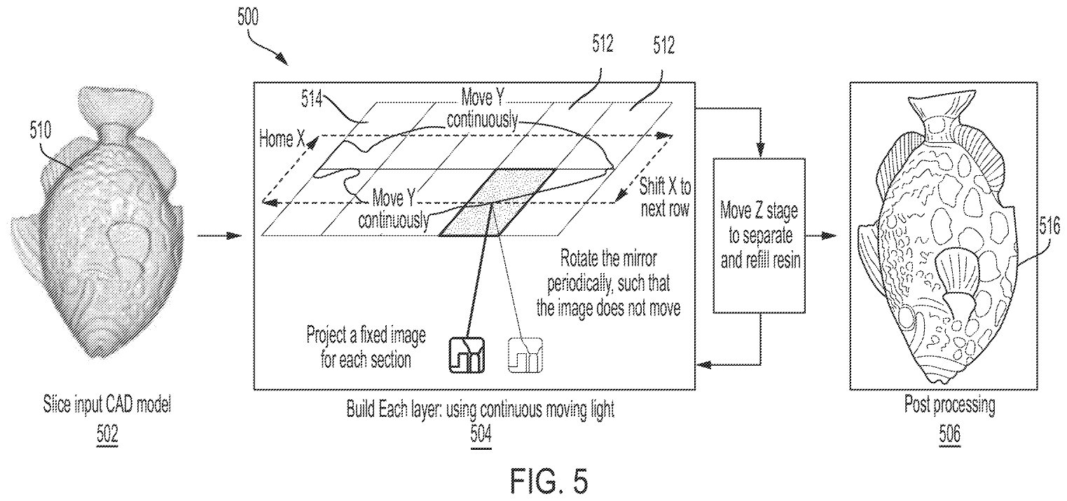

Referring now to FIG. 5, a fabrication process 500, in accordance with various embodiments. At block 502, an input three dimensional (3D) model 510 is sliced into many two dimensional (2D) layers. At block 504, each layer is further divided into many adjacent sections 512 in multiple rows 514. Each section may be further divided into multiple cycles during the hopping-based SL process. For sections in the same row 514, DMD 202 projects mask images (e.g., image pattern 214) one section 512 after another while keeping DMD 202 moving continuously. After one row is solidified, DMD 202 shifts to the next row 514, and the process is repeated by the continuously moving projection light. At block 506, after all the rows 514 are finished, the Z stage lifts to separate the fabricated layer 516 with the tank and to refill fresh resin with given layer thickness. The process is repeated until all the layers are finished. The fabricated 3D object can be taken out and be cleaned.

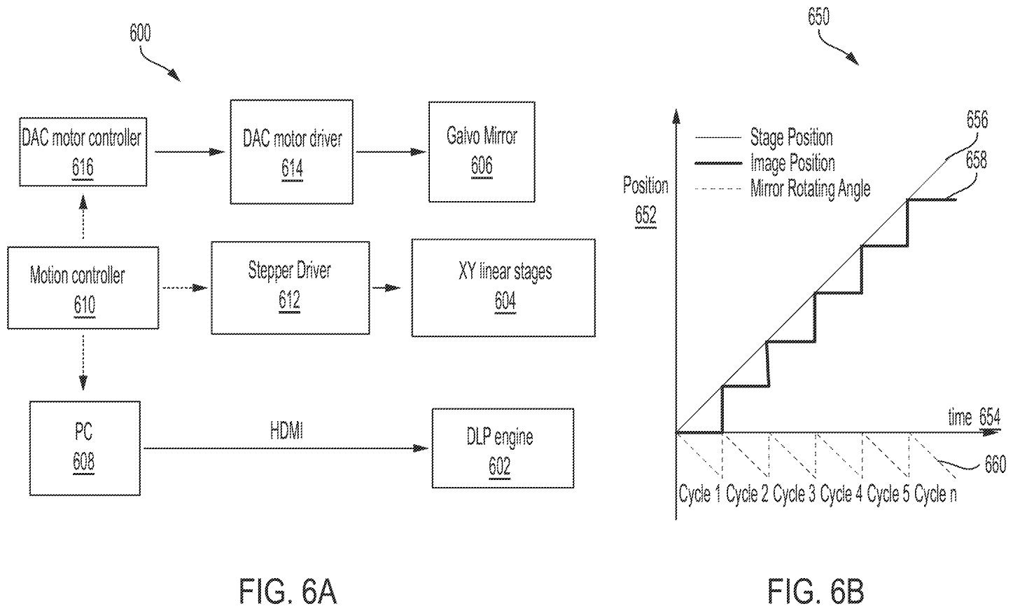

Referring now to FIGS. 6A and 6B, a framework 600 for motion synchronization is illustrated, in accordance with various embodiments. FIG. 6A is framework 600 including its various components and FIG. 6B is a graph 650 of a relationship among the components in framework 600. Framework 600 (i.e., hopping SL system) consists of three key actuation systems: an XY linear stage 604, a galvo mirror 606, and a DMD-based light engine 602. These three actuation systems work together so that the projected image can cure a small section of the large building area with little to no motion blur, and then rapidly switch to the next section using the fast motion provided by galvo mirror 606. In various embodiments, galvo-mirror 606 rotation and DMD 602 transition are synchronized via a micro-controller 608. This synchronization means two aspects, (1) the same starting time, and (2) a proper rotation to transition speed ratio, such that the projected image (e.g., image pattern 214) can stay at a fixed position. The same starting time is guaranteed through microcontroller 608 to generate a synchronization signal. The speed ratio is calibrated so that the projected image is not moving. In various embodiments, a microscope may be included to assist in observing whether the image moves or not.

The master controller is an 8-axis joint motion controller 610. In various embodiments, a KFLOP from Dynomotion in Calabasas, CA may be used. KFLOP generates synchronized signals for all three actuation systems. The XY linear stages 604 are lead-screw based stages with stepper motors driven by a stepper motor driver 612. In various embodiments, stepper motor driver 612 may be KSTEP from Dynomotion. In various embodiments, galvo mirror 606 may be from Sunny Technology (Beijing, China). Galvo mirror 606 can reflect a light beam with a diameter of 12 mm, which is sufficient for our purpose. Galvo mirror 606 is driven by a digital-to-analog (DAC) motor including a DAC motor driver 614 and a DAC motor controller 616. In various embodiments, DAC motor driver 614 and DAC motor controller 616 may be purchased from Sunny Technology. DAC motor controller 616 may be programmed before running, and the commands are stored in the buffer. Then the DAC motion can be triggered by a TTL signal, which is generated by motion controller 610 in order to synchronize galvo mirror 606 and the stages 604. Microcontroller 608 may synchronize and control the exposure time of DMD 602.

FIG. 6B shows the joint motion relationship among galvo mirror 606, XY stages 604, and the DMD 602. Graph 650 includes a first axis 652 representing position and a second axis 654 representing time. Graph 650 further includes a stage position 656, an image position 658, and a mirror rotating angle 660. As shown in Graph 650, due to the correction of galvo mirror 606, image position 658 maintains steady while the stage position 656 is moving, and then rapidly jump to the next section's position (e.g., as measured in psec).

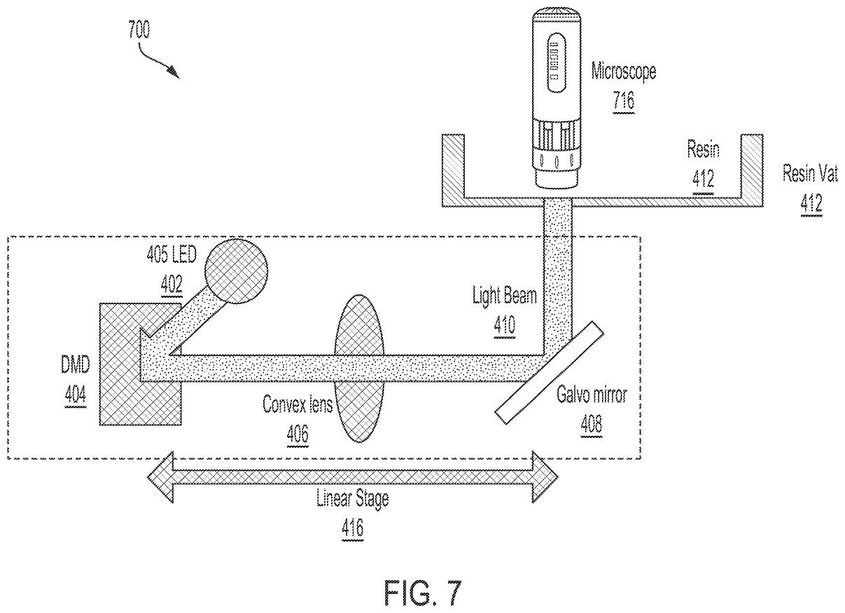

Referring now to FIG. 7, a calibration framework 700 is illustrated, in accordance with various embodiments. Calibration framework 700 includes similar components as framework 400 described in FIG. 4, including an optical module 401, a light source 402, a digital micromirror device (DMD) 404, an optic lens 406, a rotating mirror 408, a light beam 410, a resin vat 412, and liquid resin 414, descriptions of which may not be repeated here. Framework 700 further includes a microscope 716. In various embodiments, multiple calibrations may be used in the hopping SL system. First, the individual motion of each actuation systems (the mirror 408, the XY stages 416, and the DMD-based light engine 404) should be individually calibrated. Second, the speed ratio between the X linear stage 416 and the galvo mirror 408 is calculated based on the individually calibrated motion of the linear stage 416 and the mirror 408. In various embodiments, motion blur may be corrected by a specific speed ratio. Additionally, the image size (e.g., image pattern 214) should be computed based on the individual motion of the X linear stage 416 and the DMD 404 projection patterns, so that the system can update the image precisely after the linear stage 416 moves one image hopping distance. Thirdly, the whole layer is cured with successive multiple exposures. In various embodiments, the edges between different exposures may be stitched. Microscope 716 may be used to capture the projected image on the plane of resin polymerization (e.g., resin vat 412).

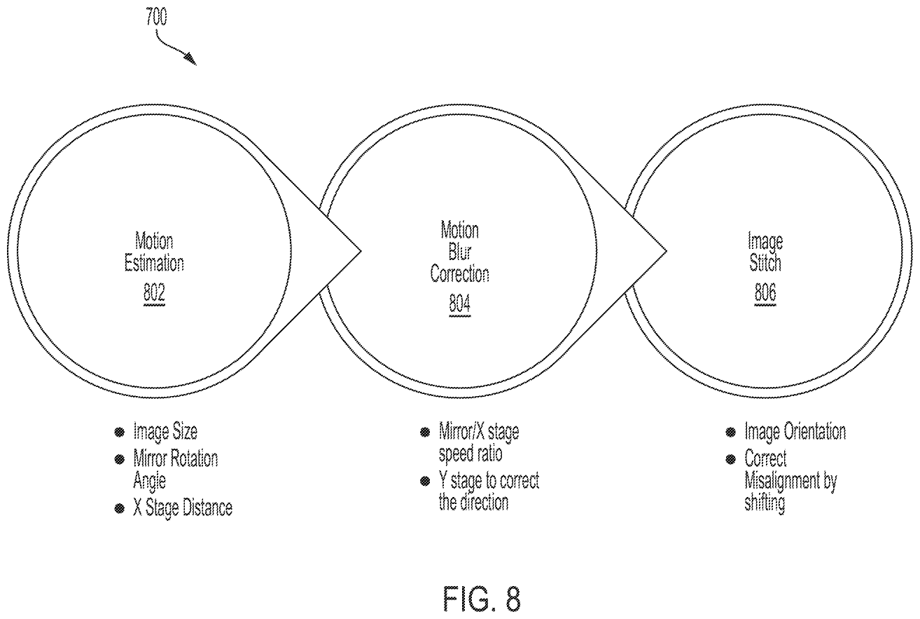

Referring now to FIG. 8, a method 800 of performing a calibration process is illustrated, in accordance with various embodiments. Method 800 may be performed by calibration framework 700 described in FIG. 7. In various embodiments, a computer vision toolbox may be utilized to do the above calibration. In various embodiments, computing device 102 runs the computer vision toolbox. In various embodiments, the computer vision toolbox may be in MATLAB. The computer vision toolbox provides the feature-based image matching. The detail calibration steps are discussed as follows.

At block 802, motion is estimated based on image size, mirror rotation angle, and/or X stage distance. At block 804, motion blur correction is determined. Motion blur correction may include determining a mirror rotation to X stage speed ratio and/or a Y stage movement to correct the direction. At block 806, the images are stitched to correct image orientation and/or misalignment due to shifting images. Each block, 802, 804, 806, will be discussed in further detail below.

The goal of the motion synchronization is to ensure that there is little to no motion blur during the continuous movement of DMD 404. Microscope 716 (e.g., a pluggable USB microscope with 2M pixels, 250× magnification, such as from Plugable) may capture the projected image on the focal plane. If the projected image from microscope 716 is not moving when the linear stages (e.g., XY linear stage 604) move, then there will be no motion blur during photo-polymerization.

Image processing algorithms may be used to analyze the captured images to detect whether the captured image is moving or not. Specifically, the computer vision toolbox (e.g., from MATLAB) is picked to do such image processing and to estimate the motions between two images. The motion estimation algorithm has three steps: 1) detecting the SURF (Speeded-Up Robust Features) features of two images; 2) matching the SURF features between two images; 3) estimating the transformations of these two images based on the matched SURF features.

In the calibration pipeline, the motion estimation tool is utilized to estimate the image motion when the system's actuators move. All the three actuation systems (the XY linear stage 604, the galvo mirror 606, and the DMD 602 patterns) can lead to changes in image positions captured by the microscope 716. We first characterized all these three actuators' motion in microscope 716 image space. Moreover, by calculating their motion relationships, we can correct the motion blur with synchronized motion.

At block 802, motion is estimated for each individual actuation system. The individual motion of each actuator is calibrated in the microscope image space, where “image space” means the images captured by the microscope. In various embodiments, the first calibration performed is to measure the size of the projected image (e.g., image pattern 214). In various embodiments, the hopping SL system may have 1:1 relay imaging, i.e., the projected image size is the DMD 404 chip's size. However, the magnification ratio may slightly deviate from 1:1 due to the fine-tune adjustment.

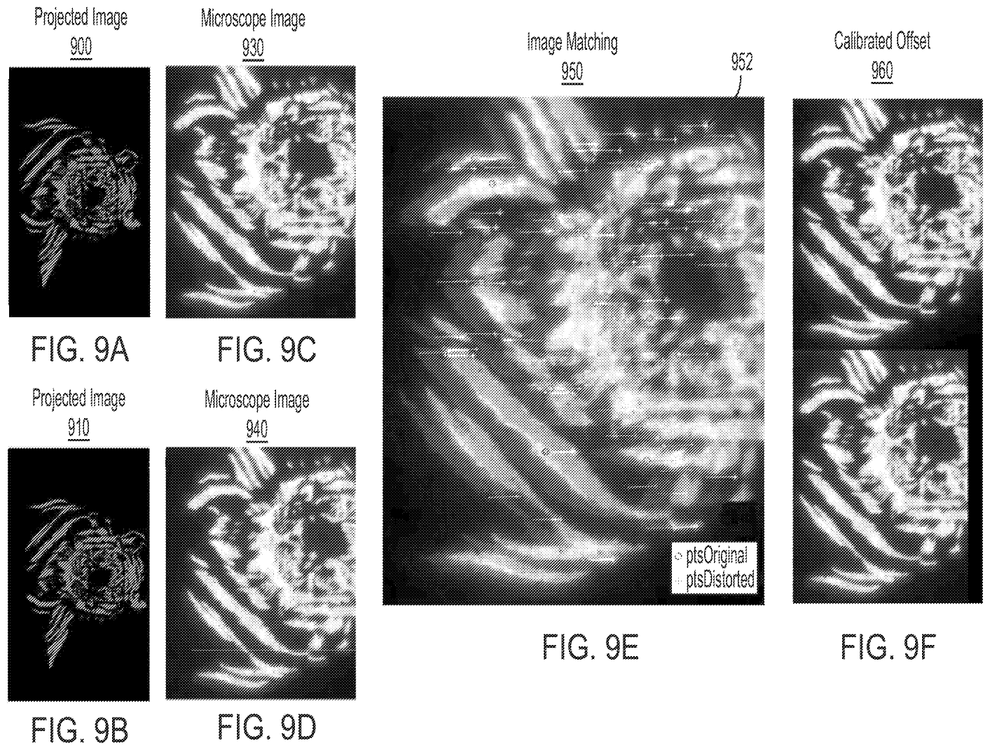

With reference to FIGS. 9A-9F, illustrated are projection pixel sizes in the microscope image space. FIG. 9A illustrates a first image pattern 900 and FIG. 9B illustrates a second image pattern 910 that is 38 pixels offset from first image pattern 900. FIG. 9C illustrates first microscope image 930 that is first image pattern 900 as captured by microscope 716. FIG. 9D illustrates second microscope image 940 that is second image pattern 910 as capture by microscope 716. Computing device 102 runs the image processing toolbox (e.g., MATLAB algorithm) to process first microscope image 930 and second microscope image 940 to determine an estimated motion. FIG. 8E illustrates an image matching 950 including pixel motion 952. FIG. 9F illustrates a calibrated offset 960 between first image pattern 900 and second image pattern.

In various embodiments, the algorithm estimates the image motion vector with an X,Y pixel offset in the image space. As illustrated in FIG. 9E, second image pattern 910 has an estimated image motion, with respect to first image pattern 900, of (34.9753, 0.6419) (unit: a pixel in image space). That is, first captured image 900 and the second captured image 910 are 0.6419 pixels offset along the height direction and 34.9763 pixels offset along the width direction, which is along the X stage. Because the input two image patterns have 38 pixels offset, hence, we can know that each pixel in the image pattern has the width of:

$$\frac{\vert ( 34 , 9753 , 0.6419 ) \vert}{38} = 0.9 \; 206 pixels$$

This value indicates the physical one pixel at the focal plane has the size of 0.9206 pixels in the microscope image. Additionally, the motion vector in microscope image space is computed as:

$${P x}^{} = ( {c}_{1}^{P x} , {c}_{2}^{P x} ) = \frac{( 34 , 9753 , 0.6419 )}{38} = ( 0.9204 , 0.0169 )$$

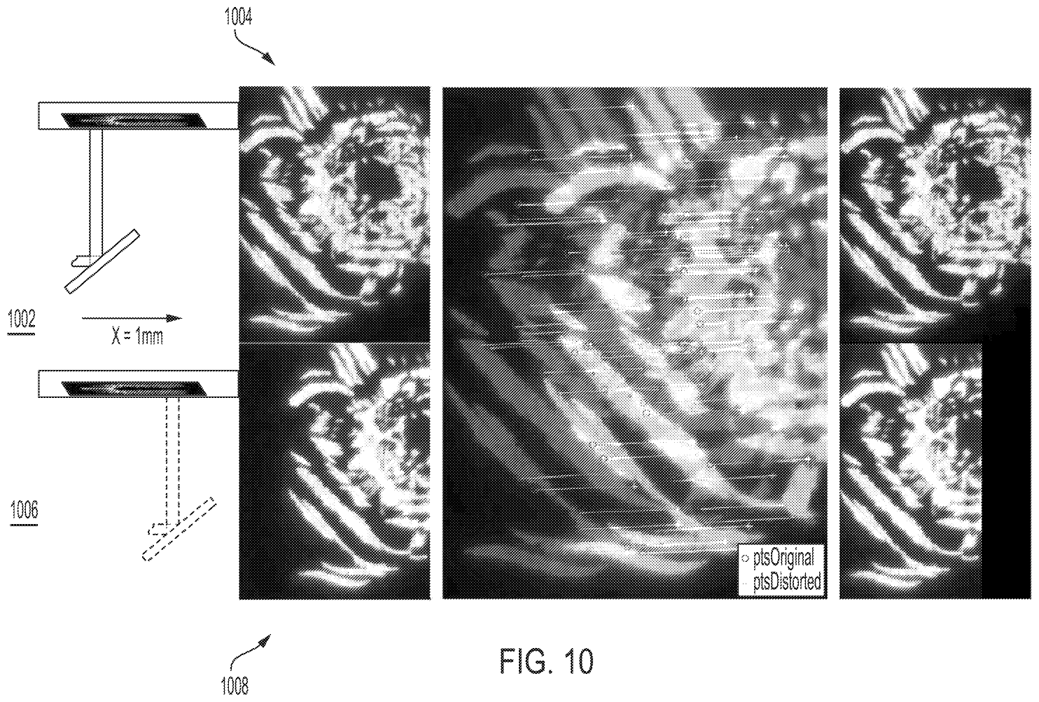

Continuing with block 802, and with reference to FIG. 10, calibration of the X stage motion in the microscope image space is performed. With the X stage at a first position 1002, the hopping SL system captures a first image 1004, moves the x stage to a second position 1004 (e.g., 1 millimeter), and captures a second image 1006. Computing device 102, using the image processing algorithm (e.g., MATLAB) estimates the image motion between first image 1004 and second image 1006. As an example, the image processing algorithm estimates the image motion as [symbol] ^{X}=(c₁^{X}, c₂^{X})=(122.3538, 5.0379) pixels. This estimated vector indicates that if the X stage moves 1 mm forward, the captured image will move 122.3538 pixels along the width direction and 5.0379 pixels along with the height direction.

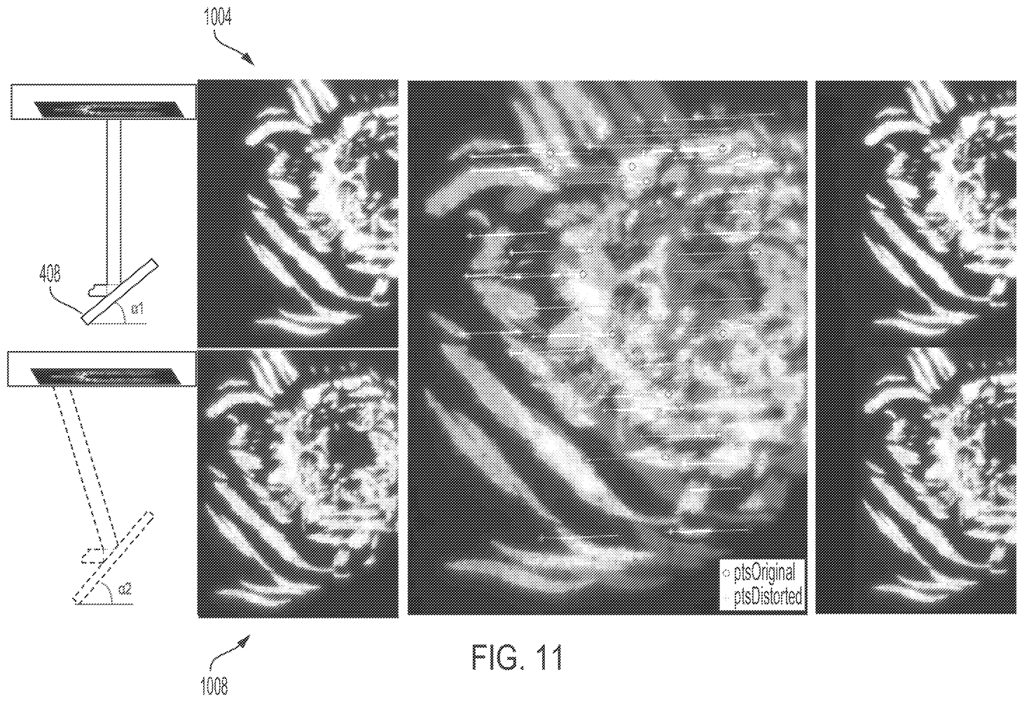

Continuing with block 802, and with reference to FIG. 11, calibration of the rotation angle in the image space is determined. The hopping SL system captures a first image 1102 with galvo mirror 408 set to a first angle α1, rotates galvo mirror 408 to a second angle α2 (e.g., about 0.36 degrees), and captures a second image 1104. A calibrated rotation angle 3 of galvo mirror 408 in the image space is determined based at least in part on the first image 1102, the second image 1104, the first angle α1, and the second angle α2.

FIG. 11 illustrates first image 1102 and second image 1104 as captured by galvo mirror 408. Computing device 102 runs the image processing algorithm to estimate the image motion between first image 1102 and second image 1104. For example, the image motion may be estimated as (−94.3139, −2.2479) (unit: pixel in image space). This result shows that if the galvo mirror 408 rotates 1 degree, then the image will move:

$${R}^{} = ( {c}_{1}^{R} , {c}_{2}^{R} ) = \frac{( - 94.31 \; 39 , - 2.2479 )}{0.36} = ( - 2 61.9831 , - 6.2442 ) pixels$$

In other words, if the galvo mirror 408 rotates 1 degree forward, the captured image (e.g., first image 1102, second image 1104, etc.) will move −261.9831 pixels along with the width and −6.2442 pixels along with height.

The above three calibrations, projected pixel size (see FIG. 9), X stage motion (see FIG. 10), and rotation angle (see FIG. 11) provide detailed procedures on how to calibrate the individual motions of the X linear stage 416, the galvo mirror 408, and the DMD 404 based image pattern from the captured images. Table 1, below, summarizes the individual calibration results.

TABLE 1

| | Actuator's | Estimated Image Motion |
|---|---|---|
| Actuator | Motion | (Pixels in Microscope) |
| X Linear Stage | 1 millimeter | [symbol] ^{X} = (c₁^{X}, c₂^{X}) = (122.3538, 5.0379) |
| Galvo Mirror | 1 degree | [symbol] ^{R} = (c₁^{R}, c₂^{R}) = (−261.9831, −6.2442) |
| DMD pattern | 1 pixel | [symbol] ^{Px} = (c₁^{Px}, c₂^{Px}) = (0.9204, 0.0169) |

At block 804, a motion blur correction is determined.

Based on the individual calibrated results determine above at block 802, an exact speed ratio and the moving distance for each mask image exposure may be determined. The galvo mirror 408 is added to cancel image blur introduced by the motion of the linear stage 416. The motion of the projected image on the focal plane is the composite motion of the linear stage 416 and the rotation of galvo mirror 408 as represented by α [symbol] ^{R}+β [symbol] ^{X}, where [symbol] ^{R} and [symbol] ^{X} represent the motion vector caused by the motion of galvo mirror 408, X stage 416, and α,β are the galvo mirror 408 rotation speed and X stage 416 moving speed, respectively. Because the projected image needs to be static during the motion of the linear stage 416, the required composite motion of the projection image is zero, i.e.

$$α {R}^{} + β {X}^{} = \vec{0} .$$

However, this condition cannot be satisfied, because [symbol] ^{R} and [symbol] ^{X} are not parallel ( [symbol] ^{R} and [symbol] ^{X}≠0). Ideally, if the optical module 401 and the linear stage 416 are well aligned, these two image motions should be parallel. However, there is typically a slight angle between these two motions. Based on the calibration this angle is:

$${θ}_{XR} = {cos}^{- 1} \frac{( {c}_{1}^{X} , {c}_{2}^{X} ) \cdot ( {c}_{1}^{R} , {c}_{2}^{R} )}{\vert ( {c}_{1}^{X} , {c}_{2}^{X} ) \cdot ( {c}_{1}^{R} , {c}_{2}^{R} ) \vert} = 0.99 degree$$

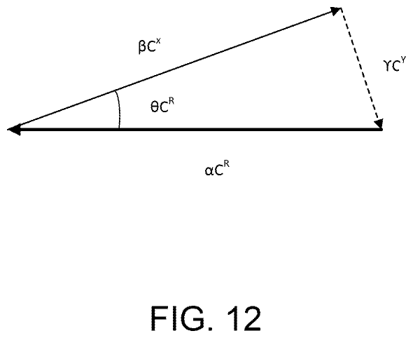

Considering this angle θ_{XR}, Y linear stage 416 may be translated to ensure the composite motion of the projected image is static. As shown in FIG. 12, the composite motion of the galvo mirror 408, X stage 416, and Y stage 416 are zero:

$$α {R}^{} + β {X}^{} + γ {Y}^{} = \vec{0 ,} \qquad ( 1 )$$

where, [symbol] ^{Y} represents the motion vector introduced by the Y stage 416, γ is Y stage 416 moving speed, α is galvo mirror 408 rotation speed, β is X stage 416 moving speed, C^{R} is the microscope image motion vector when galvo mirror 408 rotates 1 degree, C^{X} is the microscope image motion vector when X stage 416 moves 1 mm, and C^{Y} is the microscope image motion vector when Y stage 416 moves 1 mm. In various embodiments, XY stages 416 are perpendicular, so that the equation [symbol] ^{γ}=(c₂^{X}−c₁^{X}) is obtained.

By solving the above linear equation, the speed ratios may be obtained as:

$$\frac{α}{β} = \frac{{X}^{} {X}^{}}{{R}^{} {X}^{}} \qquad ( 2 )$$

$$\frac{α}{γ} = \frac{{Y}^{} {Y}^{}}{{Y}^{} {Y}^{}} \qquad ( 3 )$$

$$\frac{γ}{β} = \frac{α}{β} / \frac{α}{γ} = \frac{{X}^{} \cdot {X}^{}}{{R}^{} \cdot {X}^{}} / \frac{{Y}^{} \cdot {Y}^{}}{{Y}^{} \cdot {Y}^{}} = \frac{{R}^{} \cdot {Y}^{}}{{R}^{} \cdot {X}^{}} \qquad ( 4 )$$

By plugging the calibrated values into the hopping SL system, the speed ratio between the galvo mirror 408 and the X linear stage 416 is calculated as:

$$\frac{α}{β} = 0.4674 \frac{degree}{m m} ,$$

That is, if the X linear stage 416 moves 1 mm, the galvo mirror 408 rotates 0.4670 degrees, so that the projected image can stay at the same position. With the calibrated ratio between these two motions, the combined motion of the projection image is static. Hence no blur motion of the mask image exists when curing a section of a layer.

The speed ratio between the Y linear stage 416 and the X linear stage 416 is calculated as:

$$\frac{γ}{β} == 0.0173$$

This value shows that, if the X linear stage 416 moves 1 mm, the Y linear stage 416 moves 0.0173 mm so that the moving direction can be parallel to the image motion of the galvo mirror 408, and hence the motion blur can be corrected. Although this value is small, it will cause 0.0173*6 mm=0.1040 mm deviation for every exposure, which may not acceptable, if not considered.

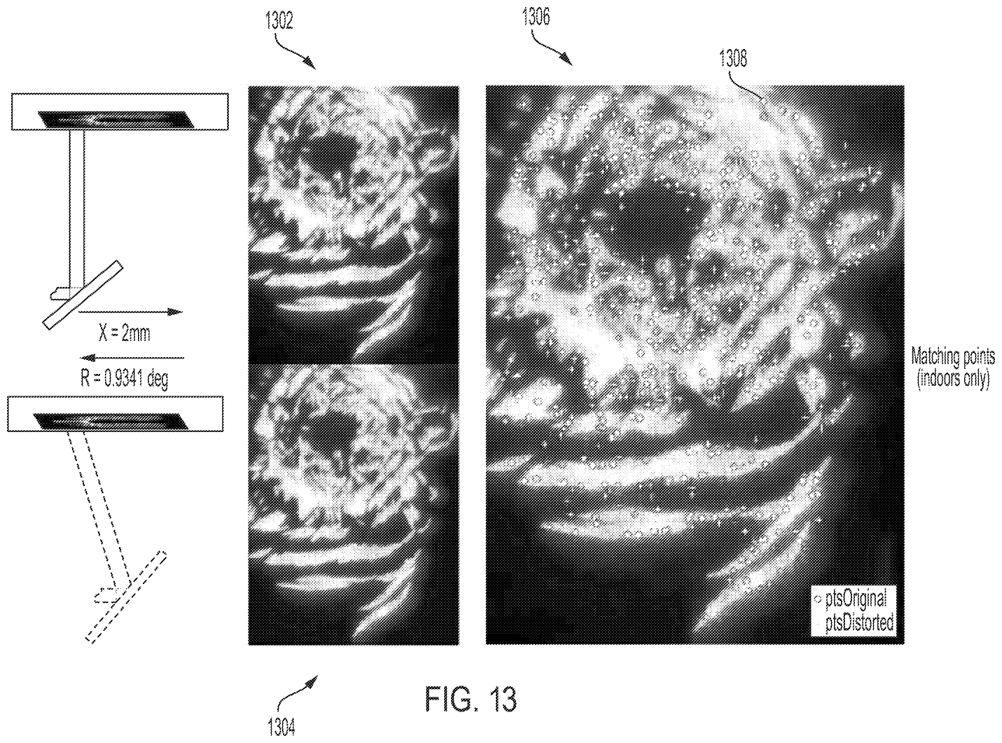

By applying this speed ratio, we recapture the images at two positions as illustrated in FIG. 13. First image 1302 and second image 1304 have less than a half pixel's motion as illustrated in an overlapped image 1306. Overlapped image 1306 indicates that by the synchronized motion, the motion blur is removed within a pixel 1308. As illustrated in overlapped image 1306, the synchronized motion can correct the motion blur between the Galvo mirror 408 and the X linear stage 416.

Continuing with block 804, a physical size of the projected image may be corrected. From the individual calibration, as described above, the X linear stage 416 motion and the projection image size in the image space are compared, and the physical size of each pixel at the focal plane is obtained:

$${W}_{p} = \frac{\vert {C}_{1}^{{P}_{x}} , {C}_{2}^{{P}_{x}} \vert}{\vert {C}_{1}^{X} , {C}_{2}^{X} \vert} = 7.5 \; 17 μm \qquad ( 5 )$$

This value is very close to the theoretical pixel size. The amplification factor is 1.0 in the hopping SL system, and the physical size of the pixel in the DMD 404 chip is 7.5 μm. Therefore, the projected image size is:

$$\begin{matrix}{S}_{X} = 7.5 \; 17 μm \cdot 800 = 6.0 \; 13 mm \\ {S}_{Y} = 7.5 \; 17 μm * 1280 = 9.6 \; 22 mm\end{matrix}$$

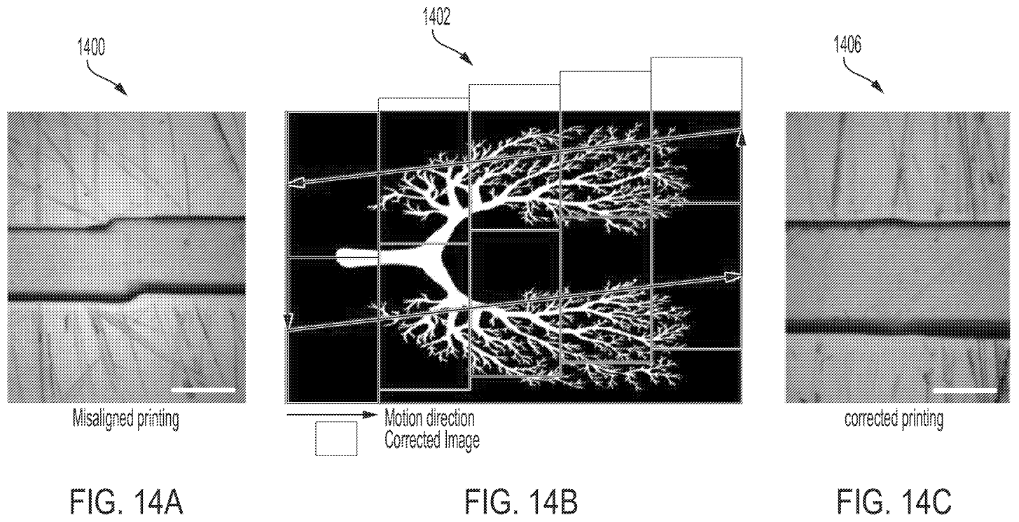

At block 806, and with reference to FIGS. 14A-14C, the image is stitched together. After the motion blur has been corrected, one layer 1400 is fabricated and observed that the edges at different exposures may not be well stitched as illustrated in FIG. 14A. This problem comes from the fact that the orientation of the projected image may not be parallel to the Galvo mirror's 408 rotation direction, which introduces the misalignment among exposures 1402 as shown in FIG. 14B.

The angle between the orientation of the projected image 1400 and the Galvo mirror's 408 rotation direction can be computed as:

$${θ}_{{P}_{x} R} = {cos}^{- 1} \frac{{\vec{C}}^{P x} \cdot {\vec{C}}^{R}}{\vert {\vec{C}}^{R} \vert \cdot \vert {\vec{C}}^{R} \vert} \qquad ( 6 )$$

To solve the problem, the image pattern for each section is offset, to follow the moving direction accordingly. For two adjacent exposures, the image should be offset

$$800 \cdot tan ( {θ}_{{P}_{x} R} ) = 14 pixels .$$

where 800 is the number of pixels along the X stage 416 direction, which is the width of the DMD 404 pattern. An angle θ_{PR} is the angle of the mirror 408 rotation direction and the image orientation. FIG. 14C illustrates a corrected image 1406 stitch based on the strategy.

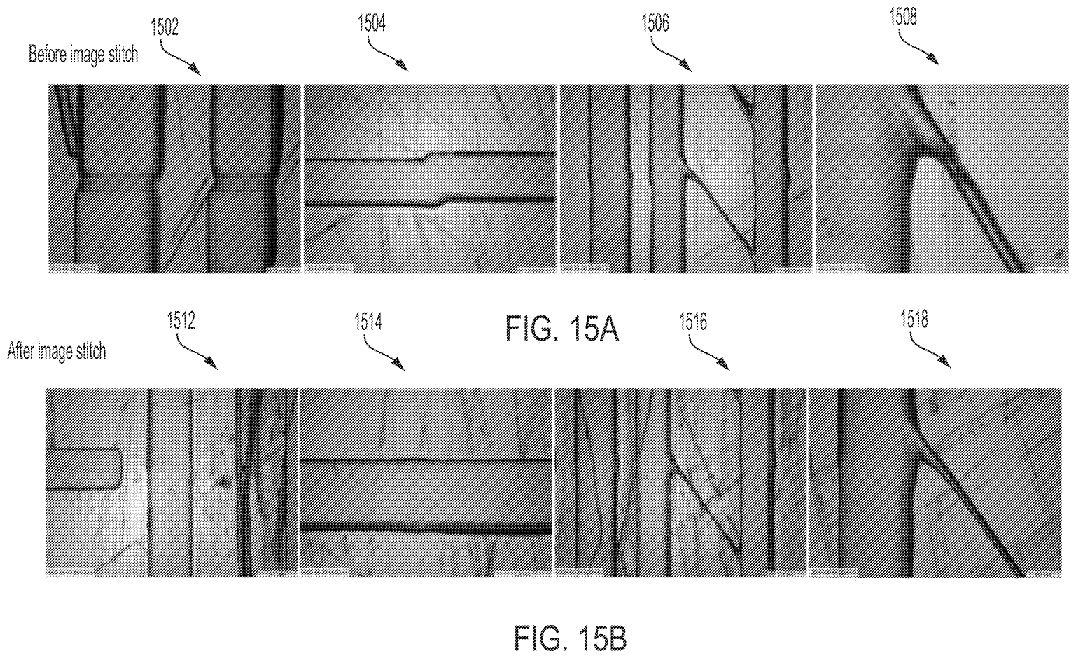

By considering the orientation, the image stitch may be fine-tuned to achieve seamless overlapping between adjacent image sections as illustrated in FIG. 13. A comparison of image stitch adjustment results is illustrated in FIGS. 15A and 15B. FIG. 15A illustrates images 1502, 1504, 1506, 1508 before the image stitching. FIG. 15B illustrates images 1512, 1514, 1516, 1518 after the image stitching with images 1512, 1514, 1516, 1518 corresponding to images 1502, 1504, 1506, 1508.

Computer vision algorithms to calibrate the process's motion parameter automatically are discussed above. The proposed calibration pipeline has three steps. Firstly, at block 802, all the actuators' motion are calibrated in the microscope image space, and three motion vectors are obtained: microscope image motion vector C^{X} when the X stage moves 1 mm, microscope image motion vector C^{R} when the gyro-mirror rotates 1 degree, microscope image motion vector C^{P}^{ₓ} when the planned image pattern shifts 1 pixel along the X axis. Then, at block 804, based on these three vectors, computer system 102 computes the speed ratio of the mirror rotation to the X stage translation, and the speed ratio of Y stage to the X stage translation in order to compensate the angle between X stage and the mirror rotation. Lastly, at block 806, reusing the three vectors, computer system 102 calibrates the angle between the image orientation and mirror rotation, and compute the offset of the image along the Y axis to compensate this angle.

To eliminate the motion blur, a galvo-mirror 408 is introduced to compensate for the image motion. However, the rotation of the light beam 410 potentially tilts the image and defocuses the projection image on the building plane (e.g., resin vat 412). Below is a discussion of tilted focus, the defocusing issue of a tilted image, and a method to address it.

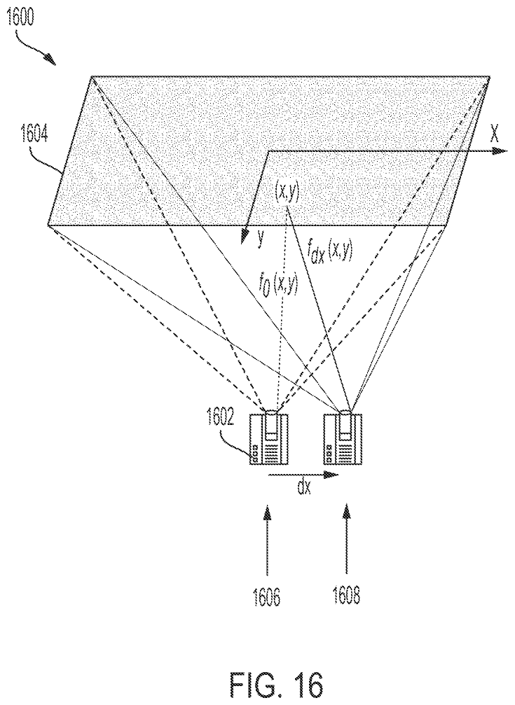

Referring now to FIG. 16, a system 1600 of analyzing the focusing error by tiling the image is illustrated, in accordance with various embodiments. System 1600 includes a projector 1602 directed at an image plane 1604 and located at a first position 1604. System 1600 further includes projector 1602 as a second position 1608 that is a distance dx from first position.

For a pixel (x, y) in an image, the well-focused length should be f₀ (x, y), while after the projector shift dr, the focus length changes to f_{dx} (x,y). The focus error should be

$$df = {f}_{d x} ( x , y ) - {f}_{0} ( x , y ) = \sqrt{{( x + d x )}^{2} + {h}^{2}} - \sqrt{{x}^{2} + {h}^{2}}$$

where h is the distance between the gyro mirror 408 and the image plane 1604.

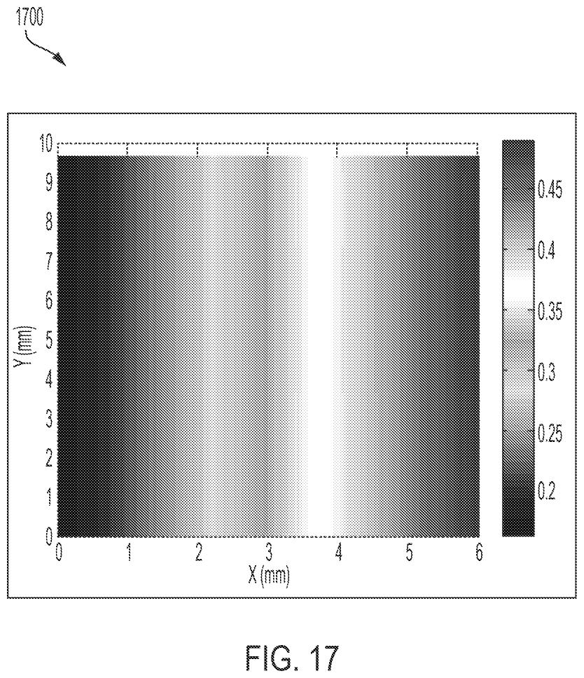

Referring now to FIG. 17, a focusing error distribution 1700 is illustrated, in accordance with various embodiments. Distribution 1700 shows the focusing error of all the pixels when the parameters are set as h=110 mm. A maximum error is located on the corner of the image, as illustrated in FIG. 14B. The maximum focus error is

$$d {f}_{max} = \sqrt{{( x + d x )}^{2} + {h}^{2}} - \sqrt{{x}^{2} + {h}^{2}} \leq \frac{dx ( dx + 2 x )}{2 h}$$

Plugging the parameters in the prototype, results in

$$d {f}_{max} = \frac{dx ( dx + 2 x )}{2 h} = \frac{6 * ( 6 + 2 * 6 )}{2 * 110} mm = 0.49 mm$$

The allowable depth of focus Δ can be estimated as

$$Δ = 2 C N \frac{V}{f} = 2 C \frac{v}{D} = 2 * 0.01 * \frac{120}{25.4} = 0.09$$

Hence, the max focusing error exceeds the allowable focus depth. To resolve the defocusing issue, a method of fractional movement is used, in which the moving dx is only a fraction of a projection image size. Consequently, the focus error can be reduced to be much smaller than the allowable focus depth.

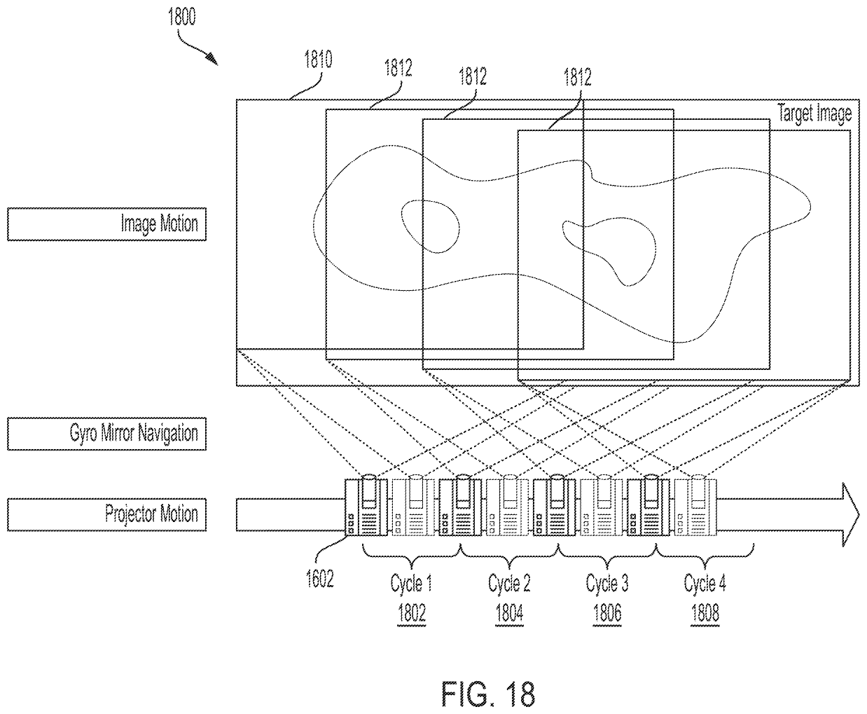

Referring not to FIG. 18, a system 1800 of projector 1602 motion is illustrated, in accordance with various embodiments. System 1800 illustrates projector 1602 moving through a first cycle 1802, a second cycle 1804, a third cycle 1806, and a fourth cycle 1808. First cycle 1802 projects a first image 1810, second cycle 1804 projects a second image 1812, third cycle 1806 projects a third image 1814, and fourth cycle 1806 projects a fourth image 1816. If the moving distance of the projector 1602 stays in the controlled value during the continuously moving process (e.g., first cycle 1802, second cycle 1804, etc.), the max focus error will be acceptable (i.e. smaller than the allowable focus depth). This indicates that once the projector 1602 moves to the critical position, the gyro-mirror 408 should start a new rotation cycle (e.g., second cycle 1804), and the DMD 404 device should prepare a new mask image to project on the building plane, as illustrated in FIG. 18.

If the moving distance for one mirror rotation is a fraction of the image size, say

$$\frac{1}{n} x ,$$

then the focus error would be

$$d {f}_{max} = \frac{\frac{1}{n} x ( \frac{1}{n} x + 2 x )}{2 h} = ( \frac{1}{n} + \frac{1}{2 {n}^{2}} ) \frac{{x}^{2}}{h}$$

By introducing cycle (e.g., cycles 1802, 1804, 1806, 1808), one section can be exposed by several images, which will reduce the moving distance for each image (e.g., images 1810, 1812, 1814, 1816), and accordingly reduce the tilt angle. Eventually, the max focus error can be reduced down to the acceptable error of the projection system 1602.

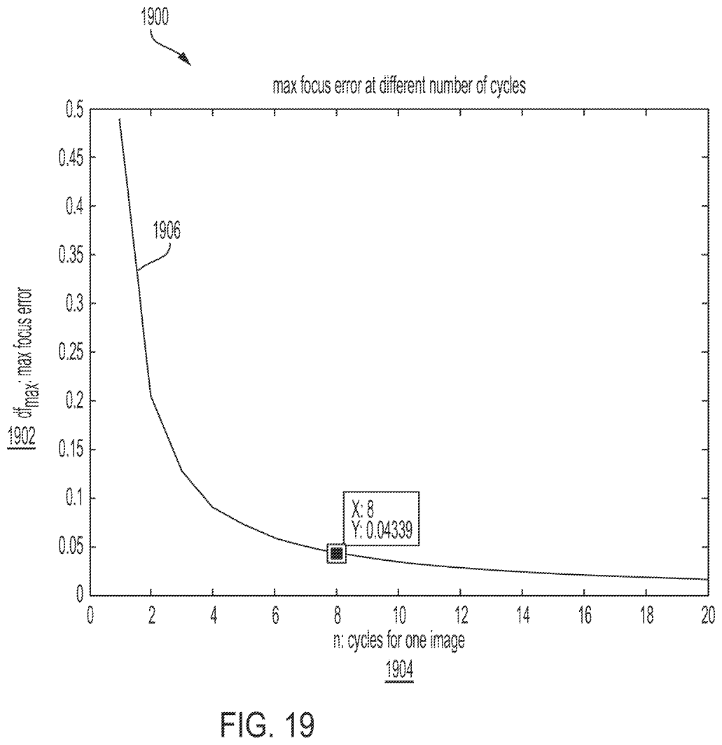

Referring now to FIG. 19, a graph 1900 of a max focus error is illustrated, in accordance with various embodiments. Graph 1900 includes a first axis 1902 representing a max focus error, a second axis 1904 representing number of cycles for one image, and a line 1906 shows that max focus error 1902 decreases with more cycles used for one image 1904.

In various examples, as illustrated in FIG. 19, the max error reduces to 0.043 mm if the moving distance is ⅛ of the image size, which is smaller than half of the depth of focus

$$\frac{Δ}{2} = 0.045 mm .$$

Eight cycles for one image means the projector 1602 should project eight images within the exposure time (800 milliseconds) for one image. This is feasible for any projector with a refresh rate of 60 Hertz. For a given depth of focus Δ,

$$d {f}_{max} \leq \frac{Δ}{2} ,$$

which gives

$$n \geq \frac{1}{\sqrt{1 + \frac{h Δ}{{x}^{2}} - 1}} \qquad ( 7 )$$

where h is the distance between the mirror and the focal plane, Δ is the depth of focus, and x is the image size. This value is the number of cycles which should decompose one image size into. In the hopping SL system, the minimum number of image cycles is

$$n \geq \frac{1}{\sqrt{1 + \frac{110 * 0.09}{{6}^{2}}} - 1} = 7.4$$

Hence, it is safe to set the number of image cycles as 8.

Described above is an analysis of the focus of a tilted image system. To solve the defocus issue introduced by image tilting, a fractional motion method, in which the moving distance for each mirror rotation cycle is only a fraction of the image size, is used. This can largely reduce the defocus effect, and also derive the required number of cycles for one image such that the defocus of a tilted image is acceptable.

Discussed below is an analysis of the performance of the proposed process, including the fabrication speed, fabrication area, and feature resolution. The theoretical analysis of the characteristics of the hopping SL system are presented. Discussed will be how to control the beam shape for different sizes, then an explanation of the process of recoating resin, and finally, the appropriate fabrication speed based on the analytic results.

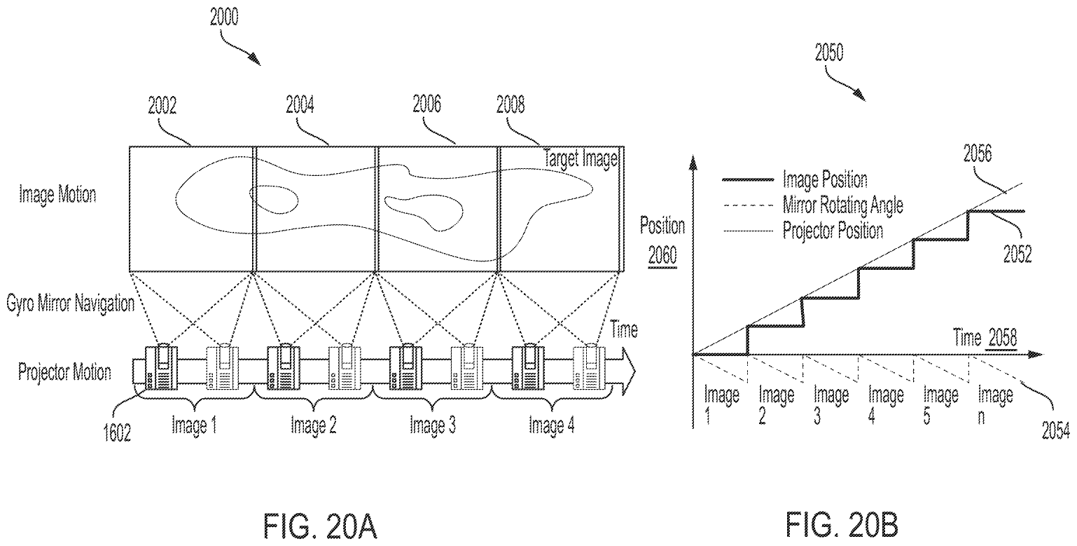

As mentioned above, a continuous moving light is generated by synchronizing the XY stage (e.g., 416) and the galvo mirror (e.g., 408), so that the projected image could stay at a fixed position as a result of the combined motion. FIG. 20A illustrates a system 2000 of how the image position is combined. System 2000 includes a projector 1602 projecting a first image 2002, a second image 2004, a third image 2006, and a fourth image 2008 as the projector 1602 moves in a first direction. FIG. 20B illustrates a graph 2050 of an image position 2052, a mirror rotation angle 2054, and a projector position 2056. Graph 2050 includes a time axis 2058 and a position axis 2060. Notice that the rotating angle of the galvo mirror (e.g., galvo mirror 208) in FIG. 20B has rapid jumps periodically (i.e., mirror rotating angle 2054), which lay the foundation of the hopping light method. The “image position” curve 2052 is the desired image motion such that the image could steadily be exposed to each section.

By comparing to the traditional discrete projector 1602 movement, the building speed is significantly improved. The required time for fabricating one section in the traditional stop-and-go process is determined as:

$${t}_{d i s} = {t}_{cure} + {t}_{trans} = \{ \begin{matrix}{t}_{cure} + \frac{L}{v} + \frac{v}{a} , if L > \frac{{v}^{2}}{a} \\ {t}_{cure} + 2 \sqrt{\frac{L}{a} ,} otherwise\end{matrix}$$

Where L is the image size, v is the maximal speed of the linear stage, and a is the maximal accelerations. In comparison, by using the continuous moving light, the building time for one section is equal to

$${t}_{con} = \{ \begin{matrix}{t}_{cure} , if {t}_{cure} > L / v \\ L / v , otherwise\end{matrix}$$

Hence, the time ratio between the conventional process and process disclosed herein is

$$\frac{{t}_{d i s}}{{t}_{c o n}} = \frac{{t}_{cure} + {t}_{trans}}{{t}_{cure}} = 1 + \frac{{t}_{trans}}{{t}_{cure}}$$

Depending on the curing time for each section, the fabrication speed ratio could reach

$$max \{ \frac{{t}_{d i s}}{{t}_{c o n}} \} = 1 + 2 \sqrt{\frac{{v}^{2}}{a s}}$$

which could be a very huge speedup if the linear stage (e.g., stage 416) has a large speed-to-acceleration ratio, where the stage needs a long time to accelerate and decelerate.

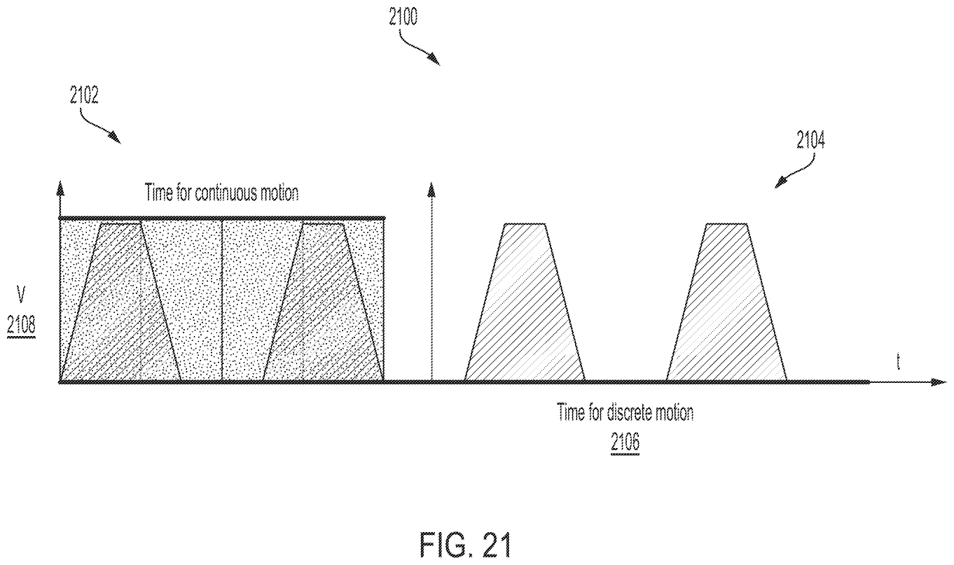

Referring now to FIG. 21, a graph 2100 that compares the effect of continuous moving light and discrete moving light is illustrated in accordance with various embodiments. Graph 2100 includes a first section 2102 illustrating the time for continuous motion and a second section 2104 illustrating the time for discrete motion. Graph 2100 includes a time axis 2106 and motion axis 2108. As implemented, the image size is L=6 mm, linear stage is vₘₐₓ=10 mm/s, and the maximal acceleration is aₘₐₓ=20 mm/s². Setting the curing time for each exposure as t_{cure}=0.8 s, the speedup is 2.38X, results in a speedup of 2.38X. Reducing the layer thickness results in reduced curing time. The process disclosed herein becomes significantly faster in the high Z resolution printing scenario.

It is also interesting to compare the proposed process with the continuous moving using a very high refresh rate projector. Besides the high cost of the projector, such process is also not feasible in high Z resolution scenario. It is because, in the high-resolution scenario, the curing time is very short (which could reach 100 ms), and the projector needs to refresh 800 images (for the image size 1280×800), which means the refresh rate reaches as high as

$$\frac{800}{0.1} = 8000 .$$

It is not feasible for current projectors available in low cost. A special controller is required for such a high refresh rate. This refresh rate will become even higher if the layer thickness continues to drop down or the pixel size of the projection image is smaller. Another issue of this high refreshing process is that the projected image is blurred to some extent due to the sweeping of pixels in the continuous movement of the projector.

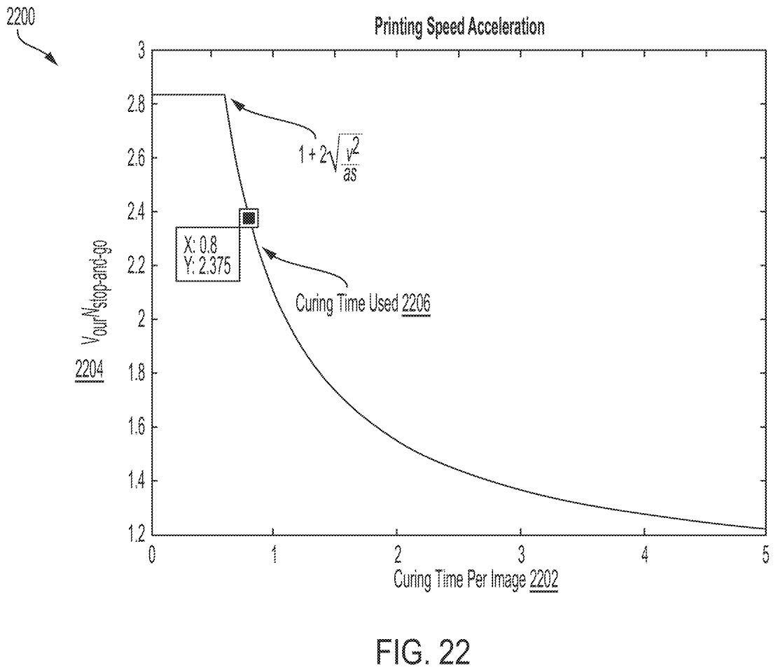

Hence, by these comparisons, the proposed process has better performance, especially when the layer thickness is small. The hopping SL system setup could fabricate parts with 200 mm size. As mentioned before, the process disclosed herein has advantages in high Z resolution scenario, which could achieve 10 μm in our current setup. Moreover, the lateral resolution is determined by the projected image size. Currently the image size is around 9.6 mm×6 mm (for 1280×800 pixels), and hence the resolution for each pixel is around 7.5 μm. FIG. 22 illustrates a graph 2200 showing the curing time 2202 as a function of start and stop speeds 2204. Point 2206 illustrates an exemplary curing time using the process disclosed herein.

In an exemplary embodiment, the hopping SL system includes the parameters set forth below in Table 2.

TABLE 2

| | |
|---|---|
| Time for a Single Exposure | 800 ms |
| Image Size | 6 mm × 9.6 mm |
| Tested Image # | 13 × 2 = 26 |
| Tested Large Image Size | 78 mm × 19.2 mm |
| Cycles Per Image | 8 |
| Stage Travel Capability | 200 mm × 100 mm × 100 mm |
| Maximum Travel Speed | 10 mm/s |
| Distance between Mirror | 110 mm |
| and the Focal Plane | |
| Light Wave Length | 405 nm |
| Layer Thickness | 0.02 mm |
| Resin Refilling Time | 20 s |
| Fab Time for 1 Cube Centimeter | 0.37 hr |

As discussed above, different SL processes have been developed to address issues in the SL process. We compare the multi-scale SL process disclosed herein with some representative SL processes, including the laser-based SLA (LSL), the projection-based micro SLA (PuSL), the two-photon polymerization (TPP), the continuous interface liquid production (CLIP), and the large area projection-based micro SLA (LaPuSL).

TABLE 3

| | | | | | | Two | |
|---|---|---|---|---|---|---|---|
| Metric | LSL | PuSL | TPP | CLIP | LaPuSL | Beams | Ours |
| Part | 125 | 3 | 0.2 | 141 | 80 | 40 | 75 |
| Size (mm) | | | | | | | |
| Feature | 155 | 3 | 0.1 | 75 | 5 | 30 | 7.5 |
| Size(um) | | | | | | | |
| Ratio | 800 | 1000 | 2000 | 1900 | 16000 | 1333 | 10000 |
| Layer | 25 | 5 | — | 1 | 5 | 20 | 20 |
| thickness | | | | | | | |
| (um) | | | | | | | |
| Speed/1 | 6 | 300 | 3000 | 0.1 | 6 | 3 | 0.4 |
| cm³ (hr) | | | | | | | |
| Cost | $$ | $$$ | $$$$ | $$$$ | $$$$ | $ | $$ |

Table 3, above, lists the details of the comparison. The processes are compared in five major fabrication metrics including part size, feature resolution, part-size-to-feature-size ratio, fabrication speed, and cost. The data in Table 3 is estimated from the referenced official website or the published paper. The ratio is calculated as the ratio part size to feature size. As shown in Table 3, the conventional SL processes face trade-offs among fabrication speed, resolution, scalability and cost. The components of the hopping SL system disclosed herein may be off-the-shelf. For example, the total cost of the hopping SL system may be less than six thousand dollars. Generally, other fabrication processes cannot provide such a combination of large fabrication part, micro-scale features, fast fabrication speed, and low cost.

The hopping SL system and process disclosed herein offers a cost-effective and robust moving light method to fabricate high-resolution features over a large area with good throughput. Computer aided design (CAD) models may be used with various geometrical complexity and sizes to verify the capability of the presented the hopping light SL process.

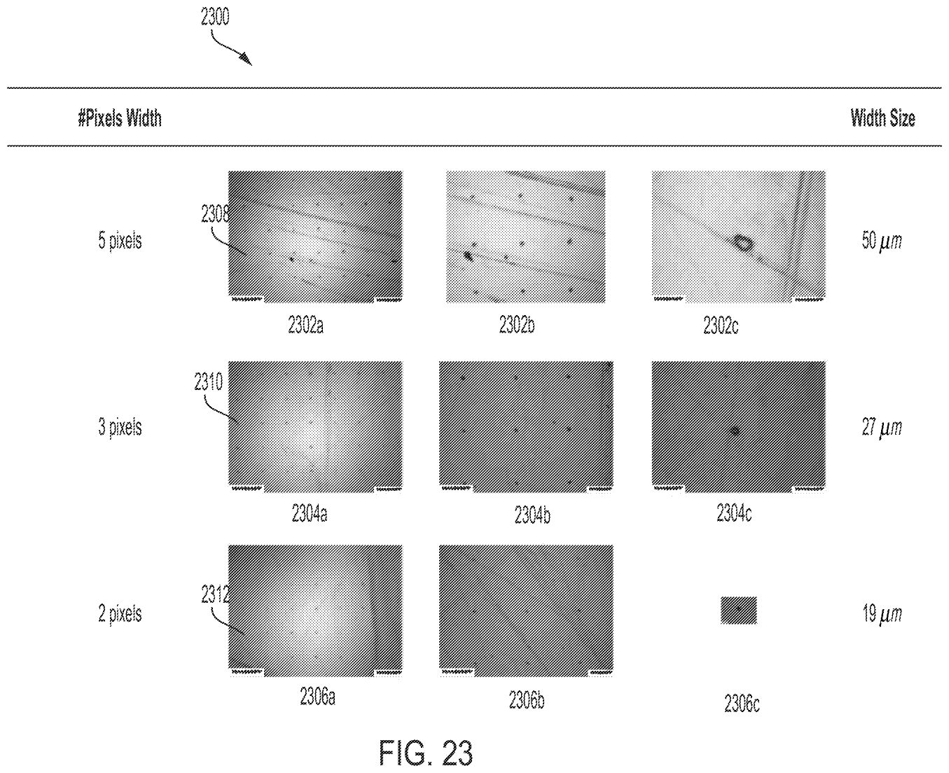

Referring now to FIG. 23, a table 2300 including small feature test prints is illustrated, in accordance with various embodiments. Table 2300 includes image patterns 2302a, 2302b, and 2302c, image patterns 2304a, 2304b, and 2304c, and image patterns 2306a, 2306b, and 2306b. Image patterns 2302a-2302c include a plurality dots 2308 uniformly printed over an area, the plurality of dots 2308 being 5 pixels wide and having a feature size of 50 μm. Image patterns 2304a-2304c include a plurality dots 2310 uniformly printed over an area, the plurality of dots 2310 being 3 pixels wide and having a feature size of 27 μm. Image patterns 2306a-2306c include a plurality dots 2312 uniformly printed over an area, the plurality of dots 2312 being 2 pixels wide and having a feature size of 19 μm. These small dots (e.g., dots 2308, 2310, 2312) are uniformly printed over a large area of 75 mm×19.2 mm.

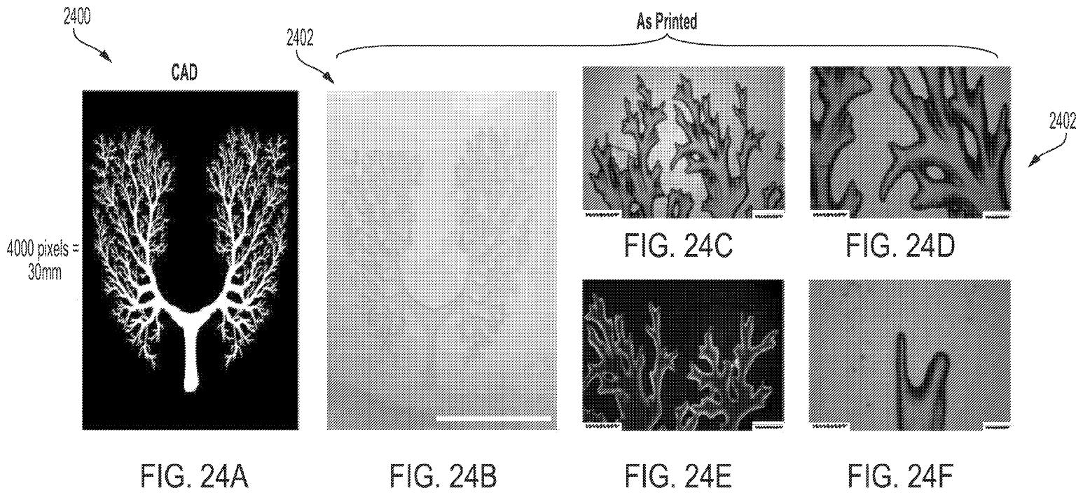

Referring now to FIGS. 24A-24F, illustrates an image of a human lung slide and fabricated results. The single image resolution of 1280×800 pixels is used to verify the moving light capability, a test image pattern 2400 with resolution 4000×2560 is selected as shown in FIG. 24A. This image pattern is divided into 5×2=10 sections. FIG. 24B illustrates a fabricated part 2402 at a 10 mm scale, FIG. 24C illustrates fabricated result 2402 at a 500 μm scale, FIG. 24D illustrates fabricated part 2402 at a 200 μm scale, FIG. 24E illustrates fabricated part 2402 at a 500 μm scale, and FIG. 24F illustrates fabricated part 2402 at a 200 μm scale. As illustrated in FIGS. 24B-24F, no stitch edges are observed, which indicates different exposures are seamless connected. The tiny “finger” in FIG. 24F is around 37 μm.

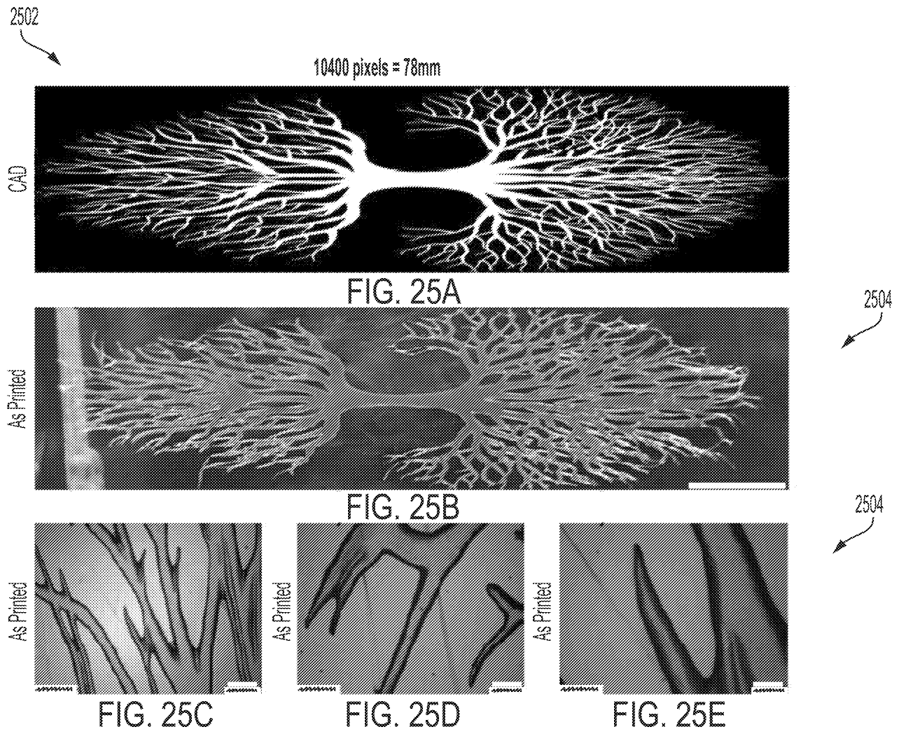

Referring now to FIGS. 25A-25E, a comparison of a CAD image pattern 2502 and the final printed part 2504 are illustrated, in accordance with various embodiments. Image pattern 2502 has a 10K resolution and is divided into 13×2=26 sections. FIGS. 25B-25E illustrate fine details of printed part 2504 using the processes disclosed herein. FIG. 25B illustrates printed part 2504 at 10 mm scale, FIG. 25C illustrates printed part 2504 at 500 μm scale, and FIG. 25E illustrates printed part 2504 at 200 μm scale. These fine features are uniformly fabricated over the very large building area 78 mm×19.0 mm.

We should mention that the building area is limited by the travel range of the hopping SL system as disclosed herein. According, the building area may be larger using a linear motion system with a larger moving area. Fabricated parts with size 200 mm×100 mm×100 mm based are feasible based on the present disclosure. And a larger size can be achieved by using XY linear stages that have larger moving distances.

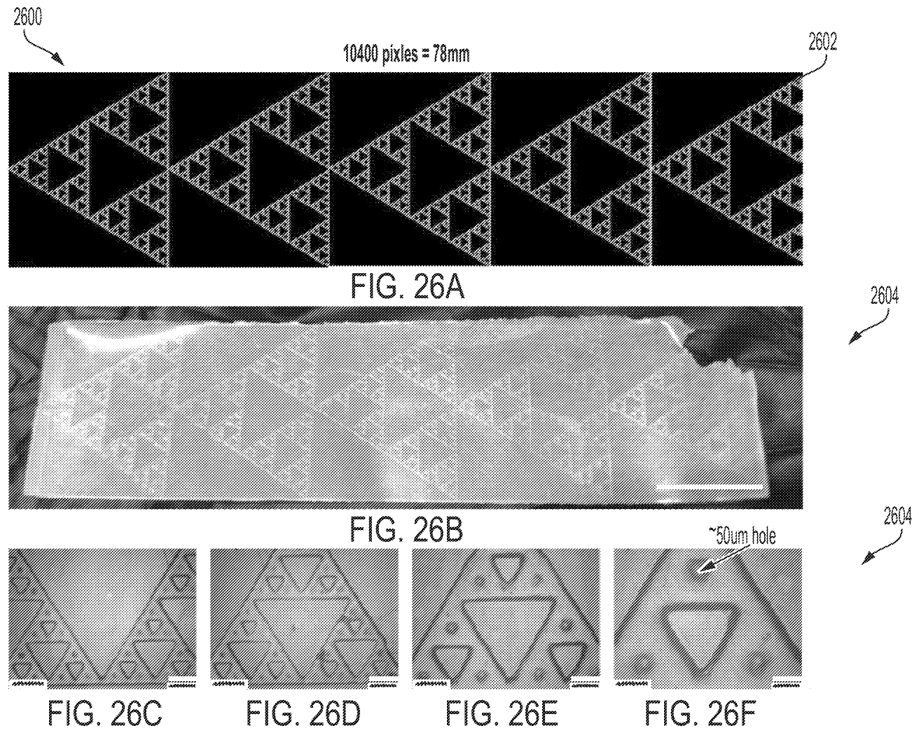

Referring now to FIGS. 26A-26F, triangle test patterns at different scales are illustrated, in accordance with various embodiments. An image pattern 2600 with triangles 2602 at different scales was designed to illustrate the fabrication capability of the hopping SL system and process. The disclosed hopping SL system and process is used to fabricate one layer of the designed pattern 2600. The printed results 2604 are shown in FIGS. 26B-26F. FIG. 26B illustrates a single layer of the printed result 2604, FIG. 26C illustrates the detailed shapes of triangles 2602 of printed result 2604 at a 500 μm scale, FIG. 26D illustrates the detailed shapes of triangles 2602 of printed result 2604 at a 500 μm scale, FIG. 26E illustrates the detailed shapes of triangles 2602 of printed result 2604 at a 200 μm scale, and FIG. 26F illustrates the detailed shapes of triangles 2602 of printed result 2604 at a 100 μm scale. The results show that it is possible to uniformly obtain 50 μm holes among a large area with 80 mm length.

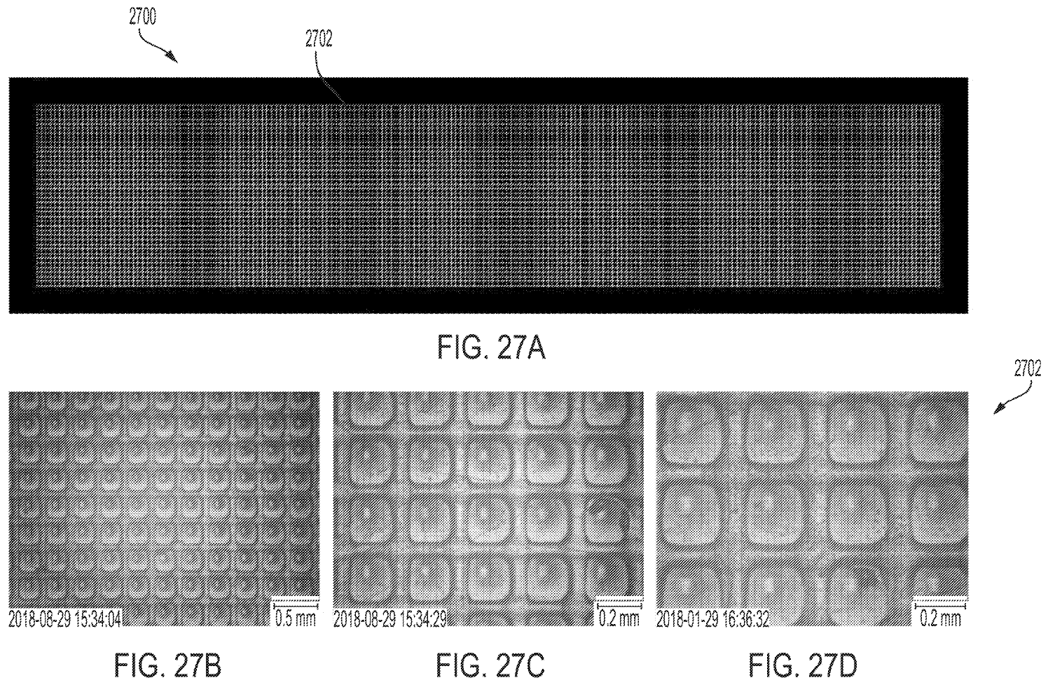

Referring now to FIGS. 27A-27D, an image pattern 2700 and printed result 2702 are illustrated, in accordance with various embodiments. Image pattern 2700 includes repeated walls 2704 having a width of about 100 μm and the repeating pitch of about 600 μm. In various embodiments, the printing area is 80 mm. Printed results 2702 includes 4 layers with each layer being about 40 μm thick. FIG. 25B illustrates printed result 2702 at a scale of 500 μm, FIG. 25C illustrates printed result 2702 at a scale of 200 μm, and FIG. 25D illustrates printed result 2702 at a scale of 100 μm.

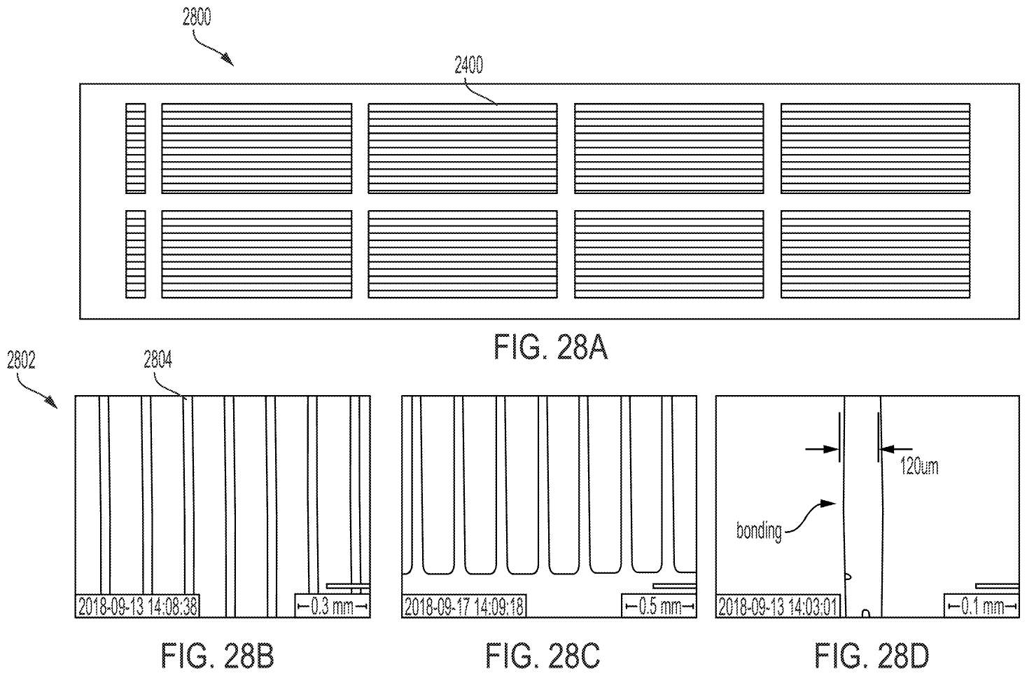

Referring now to FIGS. 28A-28D, an image pattern 2800 and printed result 2802 are illustrated, in accordance with various embodiments. Image pattern 2800, in FIG. 28A, includes grating patterns 2804 to validate the bonding between successive exposures. FIGS. 28B and 28C illustrate printed result 2802 at a 500 μm scale and FIG. 28D illustrates printed result 2802 at a 100 μm scale. FIGS. 28B-28D illustrated printed result 2802 and show that no obvious bonding defects. Moreover, FIG. 28D shows the details of bonding between two exposures. The smooth transition of two exposures at the bonding validates the disclosed hopping SL system and process.

Referring now to FIGS. 29A-29K, CAD design 2900 and printed result 2902 are illustrated, in accordance with various embodiments. FIGS. 29A-29C illustrate CAD design 2900 including an array of conical pillars 2904 having a repeating pitch is 600 μm and each pillar has a 120 μm base and 30 μm top. The height of each pillar 2904 is 2 mm. The layer thickness is 40 μm, and there are 50 layers in total. FIGS. 29D-29F are sliced image pattern 2906 of CAD design 2900. FIGS. 29G-29K illustrate the as-printed result 2902. The printed pillar 2904 has a 30 μm tip, as shown in FIG. 29K. In total, there are 4000 pillars to print with the similar quality. FIG. 29G illustrates printed result 2902 at a scale of 10 mm, FIGS. 29H and 29I illustrate printed result 2902 at a scale of 500 μm, FIG. 29J illustrates printed result 2902 at a scale of 100 μm, and FIG. 29K illustrates printed result 2902 at a scale of 20 μm.

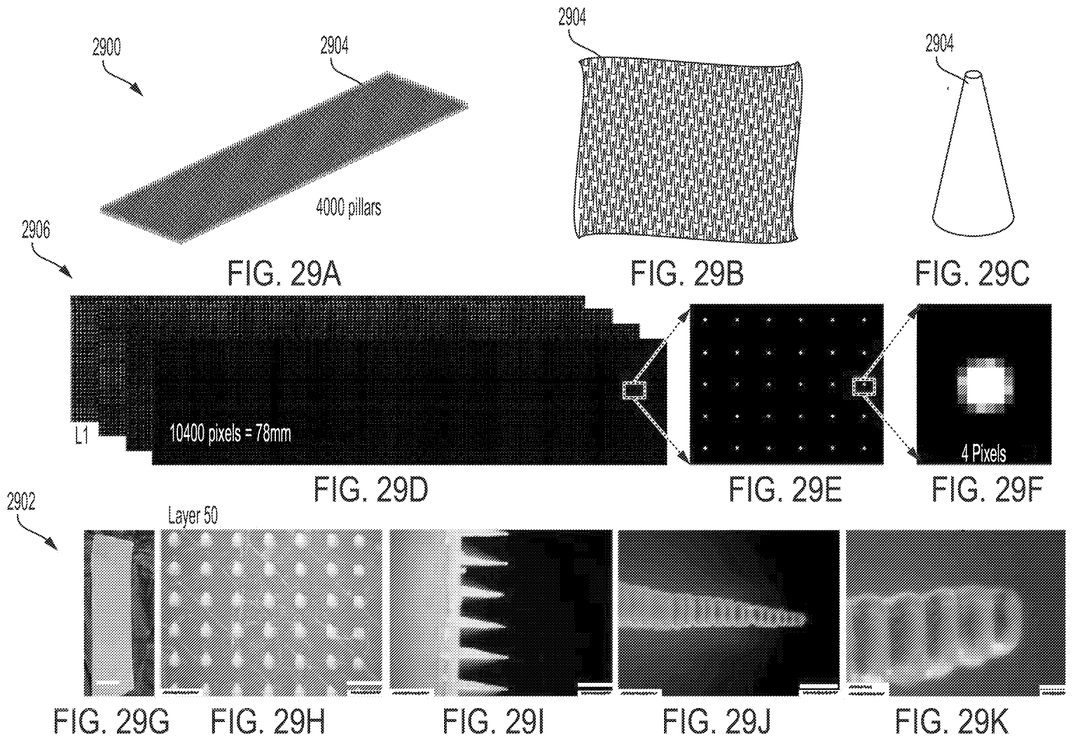

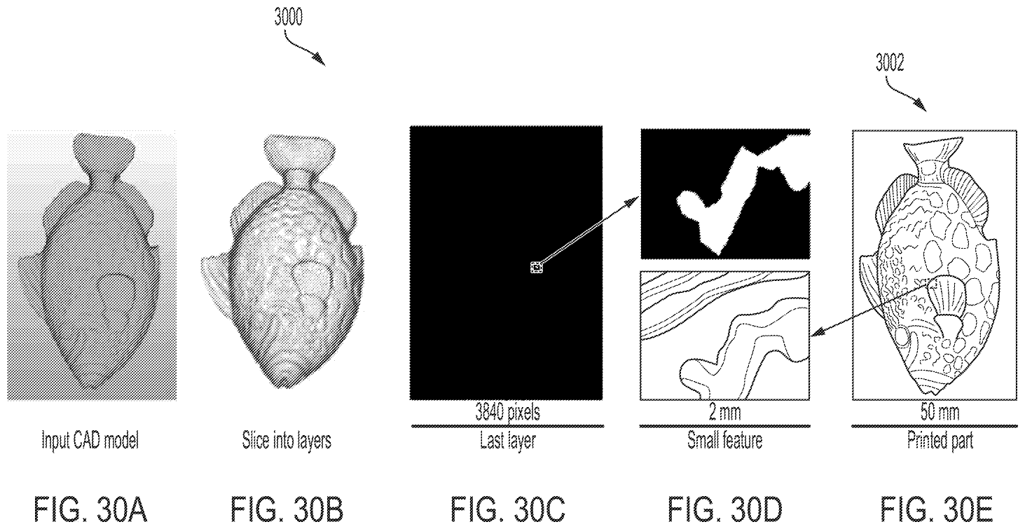

Referring now to FIGS. 30A-30E, a CAD design 3000 and printed result 3002 are illustrated, in accordance with various embodiments. CAD design 3000 is a 3D fish as illustrated in FIG. 30A. Each layer of CAD design 3000 is divided into 5×2 sections. The fabrication of this 3D object verified the capability of the hopping SL system and process disclosed herein.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor, causes the processor to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an Internet-based embodiment, an entirely hardware embodiment, or an embodiment combining aspects of the Internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY DISC®, optical storage devices, magnetic storage devices, and/or the like.

What is claimed is:

1. A stereolithography system, comprising:
a light source configured to project an image or a light onto a substrate;
a rotating mirror configured to reflect the image or the light at the substrate;
an actuator coupled to a linear stage and configured to move or position the linear stage; and
a controller coupled to the light source, the rotating mirror and the actuator and configured to:
determine a rotation speed of the rotating mirror to transition speed of the linear stage ratio that keeps the image at a fixed position,
project the image or the light onto the substrate at the fixed position, and
operate the actuator and the rotating mirror based on the rotation speed to transition speed ratio.

2. The stereolithography system of claim 1, wherein the light source is a digital micromirror device (DMD) that is configured to project the image onto the substrate, wherein the rotating mirror is a galvo mirror that is driven by a motor.

3. The stereolithography system of claim 1, wherein to operate the actuator and the rotating mirror based on the rotation speed to transition speed ratio the controller is configured to simultaneously rotate or angle the rotating mirror from a first angle to a second angle while moving the linear stage from a first position to a second position using the actuator so that the image or the light remains at the fixed position.

4. The stereolithography system of claim 3, wherein to operate the actuator and the rotating mirror based on the rotation speed to transition speed ratio the controller is further configured to:
deactivate the light source or load a black image into the light source when the linear stage reaches the second position;
rotate or angle the rotating mirror from the second angle to the first angle when the linear stage reaches the second position;
activate the light source;
load a new image related to the second fixed position into the light source;
project the image or the light onto the substrate at a second fixed position; and
rotate or angle the rotating mirror from the first angle to the second angle while moving the linear stage from the second position to a third position so that the image or the light remains at the second fixed position.

5. The stereolithography system of claim 1, wherein at least one of a timer or the controller is configured to:
control an exposure time of the projected image or light onto the substrate.

6. The stereolithography system of claim 1, wherein to operate the actuator and the rotating mirror based on the rotation speed to transition speed ratio the controller is configured to:
synchronize the projection of the image or the light, the rotation of the rotating mirror and the movement of the linear stage by the actuator to maintain the projected image or light at the fixed position while the linear stage is moving until the projected image or light jumps or hops to a second fixed position.

7. The stereolithography system of claim 1, further comprising:
a resin tank configured to store or hold the substrate, wherein the substrate is resin; and
a microscope that is configured to capture the projected image on light on a plane of the resin.

8. The stereolithography system of claim 1, wherein the controller is configured to:
individually calibrate the rotating mirror, the actuator and the light source;
estimate a transition speed of the linear stage based on a motion of the actuator;
estimate a rotation speed of the rotating mirror;
determine the rotation speed of the rotating mirror to transition speed of the linear stage ration based on the transition speed and the rotation speed to correct motion blur; and
tune an image pattern of the projected image to ensure a seamless stitch and reduce or eliminate motion blur during continuous movement of the linear stage.

9. A computer-implemented method, comprising:
determining, by a processor, a ratio of a rotation speed of a rotating mirror to a movement speed of a linear stage ratio to maintain an image at a fixed position to prevent or correct motion blur;
projecting, using the processor and by a digital micromirror device (DMD), an image onto resin at a fixed position to cure the resin; and
operating, by the processor, one or more actuators or motors to move the linear stage and rotate the rotating mirror based on the rotation speed to movement speed ratio.

10. The computer-implemented method of claim 9, further comprising:
estimating the movement speed of the linear stage based on a motion of the actuator;
estimating the rotation speed of the rotating mirror; and
determining the rotation speed of the rotating mirror to movement speed of the linear stage ratio based on the estimated movement speed and the estimated rotation speed to correct motion blur.

11. The computer-implemented method of claim 10, further comprising:
calibrating the rotating mirror, the actuator and the DMD; and
tuning an image pattern of the projected image to ensure a seamless stitch and reduce or eliminate motion blur during continuous movement of the linear stage.

12. The computer-implemented method of claim 9, wherein operating the one or more actuators or motors to move the linear stage and rotate the rotating mirror based on the rotation speed to movement speed ratio includes:
synchronizing the projection of the image, the rotation of the rotating mirror and the movement of the linear stage to maintain the projected image or light at the fixed position while the linear stage is moving until the projected image jumps or hops to a second fixed position.

13. The computer-implemented method of claim 9, wherein operating the one or more actuators or motors to move the linear stage and rotate the rotating mirror based on the rotation speed to movement speed ratio includes:
simultaneously rotating or angling the rotating mirror from a first angle to a second angle while moving the linear stage from a first position to a second position so that the image remains at the fixed position.

14. The computer-implemented method of claim 13, wherein operating the one or more actuators or motors to move the linear stage and rotate the rotating mirror based on the rotation speed to movement speed ratio includes:
deactivating the DMD when the linear stage reaches the second position;
rotating the rotating mirror from the second angle to the first angle when the linear stage reaches the second position;
activating the DMD;
projecting the image onto the resin at a second fixed position; and
rotating the rotating mirror from the first angle to the second angle while moving the linear stage from the second position to a third position so that the image remains at the second fixed position.

15. A non-transitory computer-readable medium comprising computer readable instructions, which when executed by a processor, cause the processor to perform operations comprising:
determining a ratio of a rotation speed of a rotating mirror to a movement speed of a linear stage ratio to maintain an image at a fixed position to prevent or correct motion blur;
projecting, using a digital micromirror device (DMD), an image onto resin at a fixed position to cure the resin; and
operating one or more actuators or motors to move the linear stage and rotate the rotating mirror based on the rotation speed to movement speed ratio.

16. The non-transitory computer-readable medium of claim 15, wherein the operations further comprise:
estimating the movement speed of the linear stage based on a motion of the actuator;
estimating the rotation speed of the rotating mirror; and
determining the rotation speed of the rotating mirror to movement speed of the linear stage ratio based on the estimated movement speed and the estimated rotation speed to correct motion blur.

17. The non-transitory computer-readable medium of claim 16, wherein the operations further comprise:
calibrating the rotating mirror, the actuator and the DMD; and
tuning an image pattern of the projected image to ensure a seamless stitch and reduce or eliminate motion blur during continuous movement of the linear stage.

18. The non-transitory computer-readable medium of claim 16, wherein operating the one or more actuators or motors to move the linear stage and rotate the rotating mirror based on the rotation speed to movement speed ratio includes:
synchronizing the projection of the image, the rotation of the rotating mirror and the movement of the linear stage to maintain the projected image or light at the fixed position while the linear stage is moving until the projected image jumps or hops to a second fixed position.

19. A selective laser sintering/melting system, comprising:
a light source configured to project an image or a light onto a powder;
a rotating mirror configured to reflect the image or the light at the powder;
an actuator coupled to a linear stage and configured to move or position the linear stage; and
a controller coupled to the light source, the rotating mirror and the actuator and configured to:
determine a rotation speed of the rotating mirror to transition speed of the linear stage ratio that keeps the image at a fixed position,
project the image or the light onto the powder at the fixed position, and
operate the actuator and the rotating mirror based on the rotation speed to transition speed ratio.
